(19) United States
(12) Patent Application Publication
(10) Pub. No.: US 2025/0187345 A1
(43) Pub. Date: Jun. 12, 2025

(54) PRESSURE CHANGING UNIT AND LIQUID EJECTION DEVICE

(71) Applicant: SEIKO EPSON CORPORATION, Tokyo (JP)

(72) Inventors: Takashi KOASE, SHIOJIRI-SHI (JP); Masaki SHIMOMURA, MATSUMOTO-SHI (JP); Masato OGAWA, SHIOJIRI-SHI (JP); Shotaro ONO, SHIOJIRI-SHI (JP)

(21) Appl. No.: 18/968,607

(22) Filed: Dec. 4, 2024

(30) Foreign Application Priority Data
Dec. 7, 2023 (JP) 2023-207053
Dec. 7, 2023 (JP) 2023-207054

(51) Int. Cl. B41J 2/175; H02P 6/08

(52) U.S. Cl. CPC B41J 2/17556; B41J 2/17513; H02P 6/08

(57) ABSTRACT

A pressure changing unit is a pressure changing unit that changes the pressures of multiple connect destinations, the pressure changing unit includes a motor, a pump that is connected to the motor and that is driven by the power of the motor, a switching section configured to switch the connection between the plurality of connect destinations and the pump by the power of the motor, and a transmission section positioned between the motor and the switching section, wherein the transmission section is configured to, when the motor rotates in a forward direction, not transmit power from the motor to the switching section and when the motor rotates in a reverse direction, transmit power from the motor to the switching section.

The present application is based on, and claims priority from JP Application Serial Number 2023-207053, filed Dec. 7, 2023, and from JP Application Serial Number 2023-207054, filed Dec. 7, 2023, the disclosures of which are hereby incorporated by reference herein in their entirety.

### BACKGROUND

### 1. Technical Field

The present disclosure relates to a pressure changing unit and a liquid ejection device.

### 2. Related Art

JP-A-2023-59392 describes a liquid ejection device including a pressure changing unit for changing the pressure of a plurality of connect destinations. The pressure changing unit includes a pump for changing the pressure of the plurality of connect destinations and a switching section configured to switch the connection between the pump and the plurality of connect destinations. By the switching section connecting an arbitrary connect destination and the pump, the pressure of the connect destination is changed by the pump.

Such a pressure changing unit includes a motor for driving the pump and a motor for driving the switching section separately. In this case, the pressure changing unit and the liquid ejection device may be increased in size.

### SUMMARY

A pressure changing unit for solving the above problem is a pressure changing unit for changing pressures of a plurality of connect destinations, the pressure changing unit includes a motor; a pump that is connected to the motor and that is driven by power of the motor; a switching section configured to switch connection between the plurality of connect destinations and the pump by the power of the motor; and a transmission section positioned between the motor and the switching section, wherein the transmission section is configured to, when the motor rotates in a forward direction, not transmit power from the motor to the switching section and, when the motor rotates in a reverse direction, transmit power from the motor to the switching section.

A liquid ejection device for solving the above problem includes a liquid ejection unit configured to eject liquid and a liquid supply unit configured to supply liquid to the liquid ejection unit, wherein the liquid supply unit includes a supply flow path through which liquid flows toward the liquid ejection unit and the pressure changing unit, at least either the liquid supply unit or the liquid ejection unit includes an accommodation section configured to accommodate liquid, the accommodation section includes a membrane member configured to divide the inside of the accommodation section into an air chamber and a liquid chamber, the plurality of connect destinations includes the accommodation section, and the pressure changing unit is configured to change pressure in the air chamber.

### BRIEF DESCRIPTION OF THE DRAWINGS

FIG. 1 is a perspective view showing an example of a liquid ejection device.

FIG. 2 is a front view schematically showing an internal configuration of the liquid ejection device.

FIG. 3 is a cross-sectional view showing an example of an accommodation section.

FIG. 4 is a perspective view showing an internal configuration of the liquid ejection device.

FIG. 5 is a perspective view as viewed from a different angle from that of FIG. 4.

FIG. 6 is a perspective view as viewed from a different angle from that of FIG. 4 and FIG. 5.

FIG. 7 is a perspective view as viewed from a different angle from that of FIG. 4, FIG. 5, and FIG. 6.

FIG. 8 is a perspective view of a frame and a first pump unit.

FIG. 9 is a perspective view of the first pump unit removed from the state shown in FIG. 8.

FIG. 10 is a perspective view of a liquid ejection unit.

FIG. 11 is a cross-sectional view of a flow section.

FIG. 12 is a perspective view of a flow path pump.

FIG. 13 is a cross-sectional view schematically showing the flow path pump.

FIG. 14 is a perspective view of the first pump unit.

FIG. 15 is a perspective view of a state in which the mounting member is mounted to the frame.

FIG. 16 is a front view of a state in which the first pump unit is mounted to the frame.

FIG. 17 is a front view of the inserting portion removed from the frame.

FIG. 18 is a perspective view as viewed from a different angle from that of FIG. 14.

FIG. 19 is a perspective view showing an internal configuration of the first pump unit.

FIG. 20 is a top view of a flow path member.

FIG. 21 is a view of a transmission gear and a connection gear as viewed from an axial direction.

FIG. 22 is a perspective view showing a one way clutch.

FIG. 23 is a perspective view showing a second pump unit.

FIG. 24 is a block diagram of the liquid ejection unit and a liquid supply unit.

FIG. 25 is a perspective view of a supply flow path and an air flow path.

FIG. 26 is a front view of the supply flow path and the air flow path.

FIG. 27 is a cross-sectional view of the supply flow path and the air flow path.

FIG. 28 is a perspective view of a bundling member.

FIG. 29 is a schematic diagram of a state in which the liquid ejection unit is positioned at a standby position.

FIG. 30 is a schematic diagram showing a state in which the liquid ejection unit is positioned between the standby position and a turning position.

FIG. 31 is a schematic diagram of a state in which the liquid ejection unit is positioned at the turning position.

FIG. 32 is a table showing an operation of a pressure changing unit.

FIG. 33 is a perspective view showing a modified example of the flow path member.

FIG. 34 is a schematic diagram showing an example of the liquid ejection device.

FIG. 35 is a cross-sectional view showing an example of the accommodation section.

FIG. 36 is a cross-sectional view showing an example of the flow section.

FIG. 37 is a graph showing a transition of an applied voltage.

FIG. 38 is a graph showing a pressure transition of a pressurizing air chamber.

FIG. 39 is a graph showing a pressure transition of a pressurizing liquid chamber.

### DESCRIPTION OF EMBODIMENTS

### 1. First Embodiment

Hereinafter, an embodiment of a liquid ejection device will be described with reference to the drawings. By ejecting ink, which is an example of a liquid, onto, for example, a medium such as a paper sheet or a fabric, the liquid ejection device is an inkjet printer that prints images such as characters and photographs.

### Liquid Ejection Device

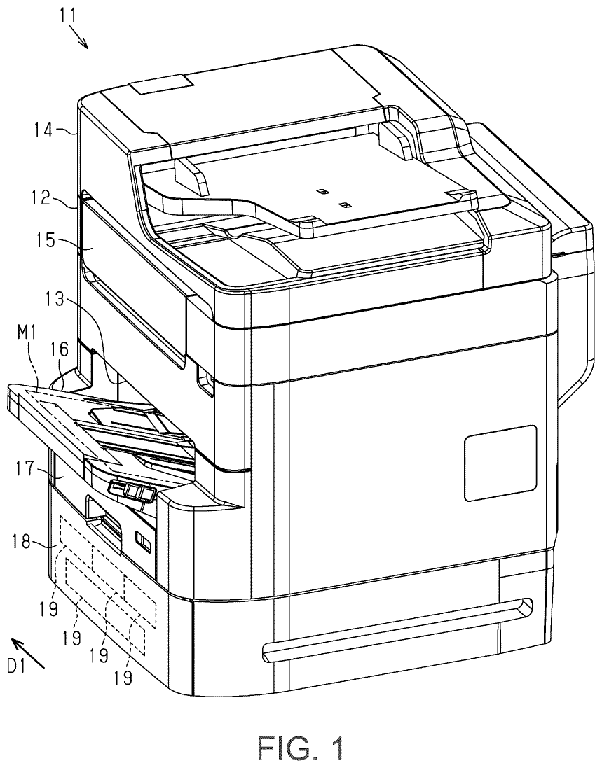

As shown in FIG. 1, a liquid ejection device 11 includes a housing 12. A discharge port 13 is opened in the housing 12. A printed medium M1 is discharged from the discharge port 13.

The liquid ejection device 11 may be provided with a reading section 14. The reading section 14 is configured to read an image recorded on a document. The reading section 14 is a scanner. For example, by automatically feeding the set documents, the reading section 14 sequentially reads the images. The reading section 14 is mounted on the housing 12. The reading section 14 is mounted on, for example, an upper portion of the housing 12. In one example, the reading section 14 is mounted to the housing 12 so as to be openable and closable. When the reading section 14 is opened with respect to the housing 12, the inside of the housing 12 is exposed. By the reading section 14 opening, a user can access the inside of the housing 12 from the upper portion of the housing 12.

The liquid ejection device 11 includes an operation section 15. The operation section 15 is an interface for the user to operate the liquid ejection device 11. The operation section 15 is, for example, a touch panel. The operation section 15 may include a button, a lever, a switch, or the like. The operation section 15 is positioned, for example, on the front surface of the housing 12.

The liquid ejection device 11 may include a discharge tray 16. The discharge tray 16 receives the printed medium M1. The discharge tray 16 receives the medium M1 discharged from the discharge port 13. The discharge tray 16 extends from the discharge port 13. In one example, the discharge tray 16 extends through the discharge port 13 from within the housing 12 toward the front of the liquid ejection device 11.

The liquid ejection device 11 includes a medium accommodation section 17. The medium accommodation section 17 is configured to accommodate the medium M1. The medium accommodation section 17 accommodates the medium M1 before printing. The medium accommodation section 17 is a cassette. The medium accommodation section 17 is configured, for example, to be inserted into and removed from the housing 12.

The liquid ejection device 11 includes a mount section 18. The mount section 18 is configured to have one or more mounting bodies 19 mounted thereon. In one example, four mounting bodies 19 are mounted on the mount section 18. The mounting body 19 is a cassette. The mounting body 19 is configured, for example, to be insertable into and removable from the mount section 18.

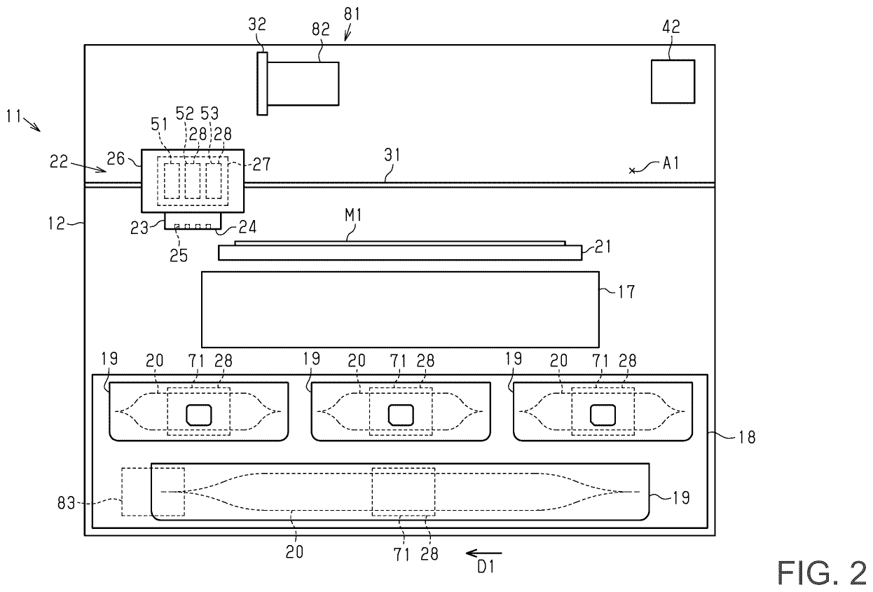

As shown in FIG. 2, the mounting body 19 is configured to allow liquid accommodation bodies 20 to be mounted thereon. The liquid accommodation body 20 is a container that accommodates a liquid. The liquid accommodation body 20 is, for example, an ink pack. The liquid accommodation body 20 is mounted on the mount section 18 via the mounting body 19. In one example, four liquid accommodation bodies 20 are mounted on the mount section 18. The four liquid accommodation bodies 20 may accommodate different liquids. For example, the four liquid accommodation bodies 20 may accommodate cyan ink, magenta ink, yellow ink, and black ink. By the liquid accommodation body 20 mounting on the mount section 18, the liquid is supplied from the liquid accommodation body 20 to the liquid ejection device 11.

The liquid ejection device 11 includes a medium support section 21. The medium support section 21 supports the medium M1 transported from the medium accommodation section 17. The medium support section 21 supports the medium M1 while the liquid is being ejected. The medium support section 21 supports the medium M1 being printed.

The liquid ejection device 11 includes a liquid ejection unit 22. The liquid ejection unit 22 is configured to eject the liquid onto the medium M1. The liquid ejection unit 22 ejects the liquid onto the medium M1 supported by the medium support section 21. The liquid ejection unit 22 is configured such that the liquid is supplied from the liquid accommodation body 20.

The liquid ejection unit 22 includes an ejection section 23. The ejection section 23 includes a nozzle surface 24. The nozzle surface 24 is a surface facing the medium M1. One or more nozzles 25 are opened in the nozzle surface 24. The ejection section 23 ejects the liquid from the nozzles 25.

The liquid ejection unit 22 is configured to move in a scanning direction D1. Specifically, the liquid ejection unit 22 is configured to move in the scanning direction D1 and the opposite direction. The liquid ejection unit 22 reciprocates on the medium M1. As a result, the liquid ejection unit 22 can eject the liquid over the entire width of the medium M1. In one example, the liquid ejection unit 22 is a serial head. The liquid ejection unit 22 may be a line head capable of ejecting the liquid simultaneously over the entire width of the medium M1.

The liquid ejection unit 22 may include a movable body 26. The movable body 26 mounts the ejection section 23 thereon. The movable body 26 moves in the scanning direction D1 within the housing 12. Specifically, the movable body 26 moves in the scanning direction D1 and the opposite direction. The movable body 26 moves in a movement region A1. The movement region A1 is an area including above the medium support section 21.

The movable body 26 moves between a standby position and a turning position in the movement region A1. The standby position is a position at which the movable body 26 waits. For example, when the liquid ejection unit 22 does not eject the liquid onto the medium M1, the movable body 26 is positioned in the standby position. The turning position is a position at which the movable body 26 turns back the movement in the opposite direction from the scanning direction D1. The standby position and the turning position are positions that are the ends of the movement region A1. In one example, in FIG. 2, the movable body 26 is positioned at the turning position.

The liquid ejection unit 22 includes a flow section 27. In the flow section 27, the liquid supplied to the ejection section 23 flows. The flow section 27 is connected to the ejection section 23. The flow section 27 is positioned between the liquid accommodation body 20 and the ejection section 23. In one example, the flow section 27 is mounted on movable body 26. The flow section 27 will be described later.

The liquid ejection device 11 includes one or more accommodation sections 28. In one example, the liquid ejection device 11 includes a plurality of accommodation sections 28. The accommodation section 28 is configured to accommodate the liquid. The accommodation section 28 is connected to the ejection section 23. The accommodation section 28 may be directly connected to the ejection section 23 or may be indirectly connected to the ejection section 23 via another configuration. The liquid accommodated in the accommodation section 28 is supplied to the ejection section 23. The accommodation section 28 is positioned between the liquid accommodation body 20 and the ejection section 23. The accommodation section 28 accommodates the liquid between the liquid accommodation body 20 and the ejection section 23. The accommodation section 28 is, for example, an opening and closing valve 52, a pressurizing section 53, a flow path pump 71, and the like. The opening and closing valve 52, the pressurizing section 53, and the flow path pump 71 will be described later.

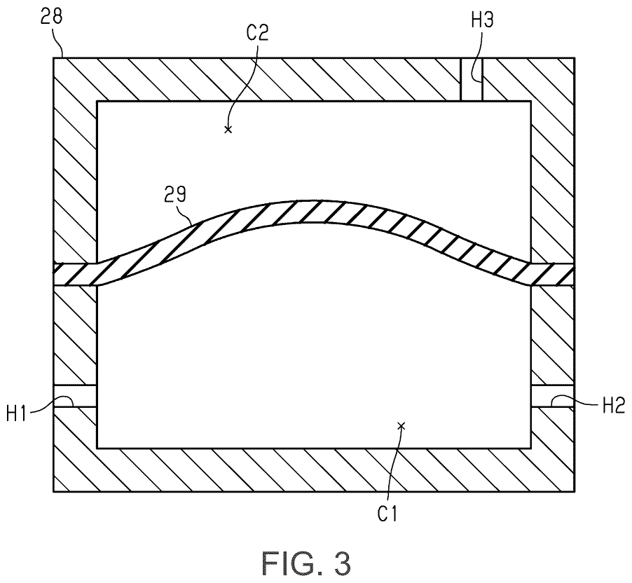

Based on FIG. 3, a common configuration of the accommodation section 28 will be described. The accommodation section 28 includes a membrane member 29. The membrane member 29 is a flexible member. The membrane member 29 is deformable. The membrane member 29 divides the inside of the accommodation section 28 into a liquid chamber C1 and an air chamber C2. The liquid chamber C1 is a space in which the liquid is accommodated. The liquid chamber C1 communicates with the ejection section 23. The air chamber C2 is a space in which air is accommodated. The air chamber C2 communicates with a pressure changing unit 81 (to be described later). The membrane member 29 partitions the liquid chamber C1 and the air chamber C2. The membrane member 29 constitutes a wall surface of the liquid chamber C1 and a wall surface of the air chamber C2. The membrane member 29 is deformed according to the pressure in the liquid chamber C1 and the pressure in the air chamber C2. When the membrane member 29 is deformed, the volume of the liquid chamber C1 and the volume of the air chamber C2 change.

A plurality of openings are formed in the accommodation section 28. Through the plurality of openings, the liquid and air are supplied to and discharged from with respect to the accommodation section 28. In one example, an inflow port H1, an outflow port H2, and an air port H3 are opened in the accommodation section 28. The inflow port H1 communicates with the liquid chamber C1. The liquid flows into the liquid chamber C1 through the inflow port H1. The outflow port H2 communicates with the liquid chamber C1. The liquid flows out from the liquid chamber C1 through the outflow port H2. The air port H3 communicates with the air chamber C2. Through the air port H3, air is supplied to or discharged from the air chamber C2. That is, the air chamber C2 is pressurized or depressurized through the air port H3. When the air chamber C2 is pressurized, the membrane member 29 deforms so as to increase the volume of the air chamber C2. In other words, the membrane member 29 is deformed so as to reduce the volume of the liquid chamber C1. As a result, the liquid flows out from the liquid chamber C1 through the outflow port H2. When the air chamber C2 is depressurized, the membrane member 29 deforms so as to reduce the volume of the air chamber C2. In other words, the membrane member 29 is deformed so as to increase the volume of the liquid chamber C1. As a result, the liquid flows into the liquid chamber C1 through the inflow port H1.

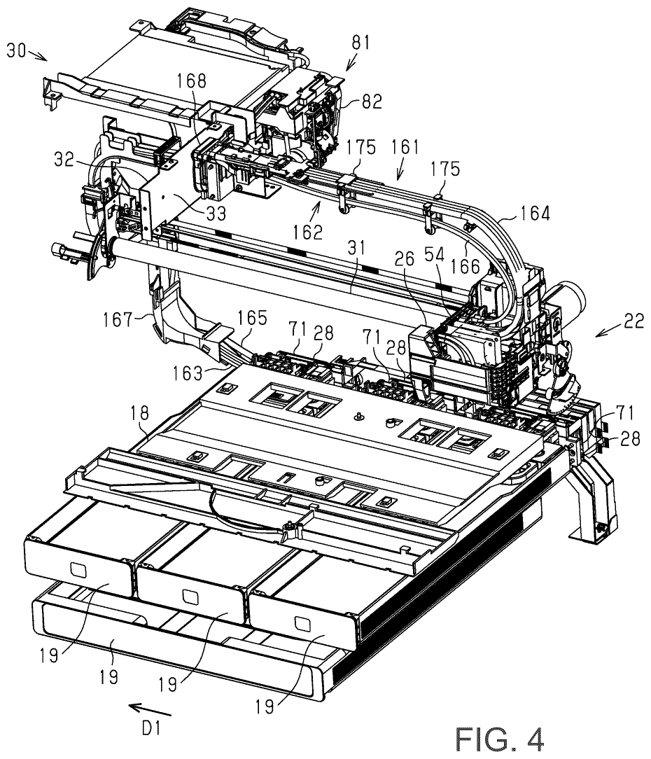

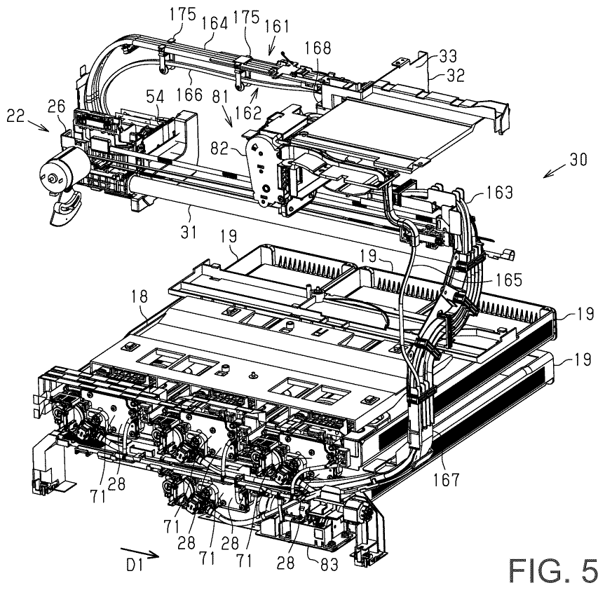

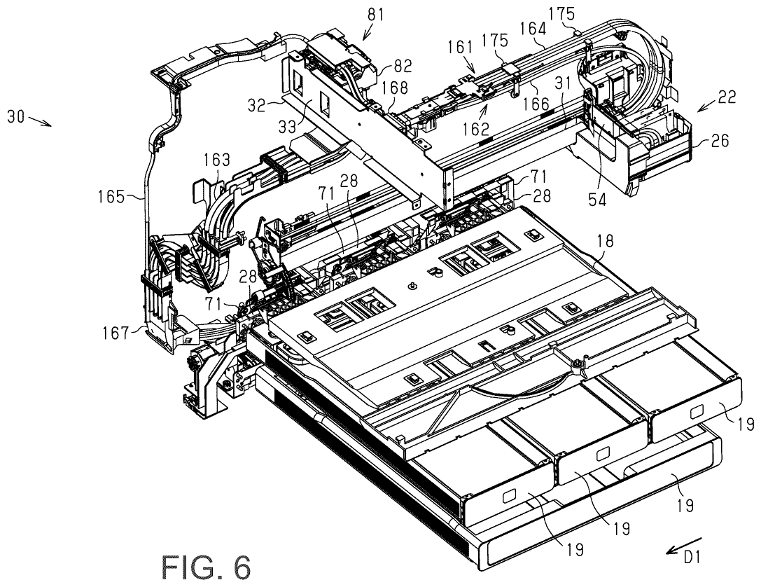

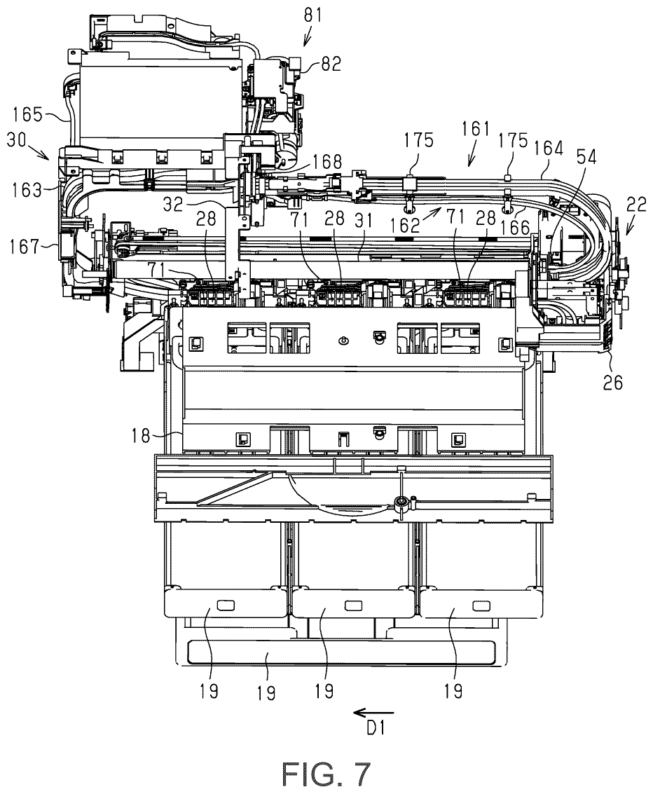

As shown in FIG. 4, FIG. 5, FIG. 6, and FIG. 7, the liquid ejection device 11 includes a liquid supply unit 30. The liquid supply unit 30 is configured to supply the liquid to the liquid ejection unit 22. The liquid supply unit 30 supplies the liquid to the ejection section 23. The liquid supply unit 30 supplies the liquid from the liquid accommodation body 20 to the ejection section 23. The liquid supply unit 30 is connected to the liquid ejection unit 22. The liquid supply unit 30 is connected to the mount section 18. The liquid supply unit 30 is connected to the liquid accommodation body 20 via the mount section 18. The liquid supply unit 30 will be described later.

At least either the liquid ejection unit 22 and the liquid supply unit 30 includes the accommodation section 28. The liquid ejection unit 22 may include the accommodation section 28 or the liquid supply unit 30 may have the accommodation section 28. Only the liquid ejection unit 22 may include the accommodation section 28, only the liquid supply unit 30 may have the accommodation section 28, or both the liquid ejection unit 22 and the liquid supply unit 30 may include the accommodation section 28. In one example, both the liquid ejection unit 22 and the liquid supply unit 30 include the accommodation section 28.

Each of the liquid ejection unit 22 and the liquid supply unit 30 includes one or more accommodation sections 28. Each of the liquid ejection unit 22 and the liquid supply unit 30 may include one accommodation section 28 or a plurality of accommodation sections 28. Either the liquid ejection unit 22 or the liquid supply unit 30 may include one accommodation section 28, and the other may have a plurality of accommodation sections 28.

The accommodation section 28 is provided in the liquid ejection unit 22 or the liquid supply unit 30. Each of the plurality of accommodation sections 28 is provided in the liquid ejection unit 22 or the liquid supply unit 30. The plurality of accommodation sections 28 may include one or more accommodation sections 28 provided in the liquid ejection unit 22 and one or more accommodation sections 28 provided in the liquid supply unit 30.

The liquid ejection device 11 may include a moving shaft 31. The moving shaft 31 is a shaft for supporting the movable body 26. The moving shaft 31 extends in the scanning direction D1. The moving shaft 31 guides the movable body 26. The movable body 26 moves along the moving shaft 31.

The liquid ejection device 11 includes a frame 32. The frame 32 supports the liquid supply unit 30. Specifically, the frame 32 supports the pressure changing unit 81. More specifically, the frame 32 supports a pump unit (to be described later). In one example, the frame 32 supports a first pump unit 82 (to be described later).

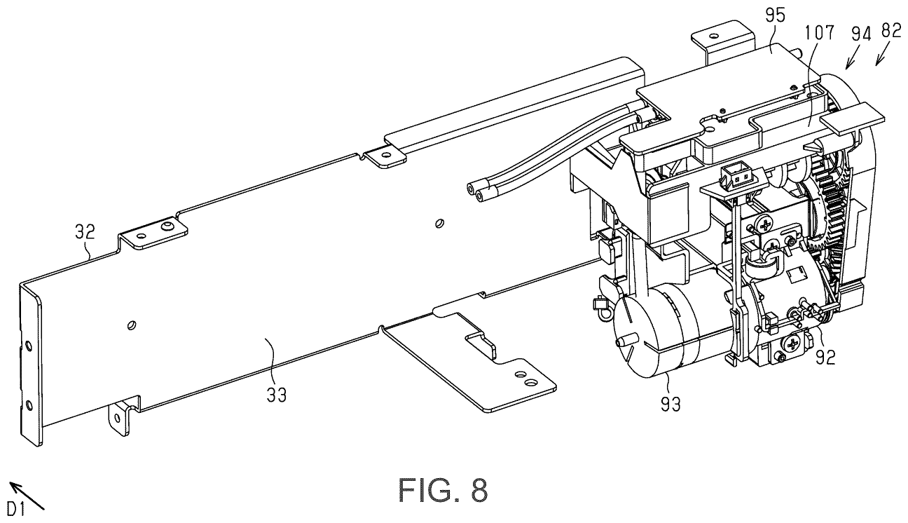

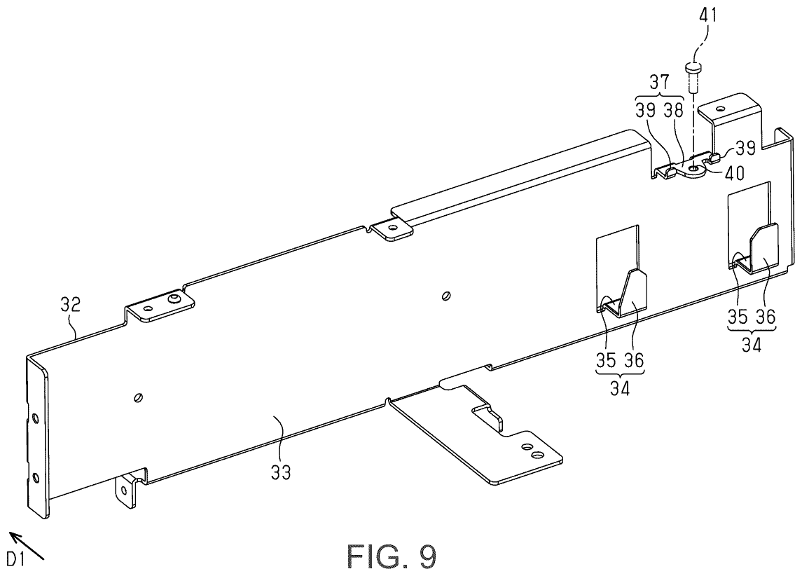

As shown in FIG. 8 and FIG. 9, the frame 32 includes a support plate 33. The support plate 33 faces the first pump unit 82. The support plate 33 extends in a direction perpendicular with respect to the scanning direction D1.

The frame 32 includes one or more support portions 34. In one example, the frame 32 includes two support portions 34. The support portion 34 is a portion that supports the first pump unit 82. The support portion 34 extends from the support plate 33.

The support portion 34 includes a first support piece 35 and a second support piece 36. The first support piece 35 extends from the support plate 33. The first support piece 35 extends perpendicularly from the support plate 33. The first support piece 35 extends so as to close to the first pump unit 82. The second support piece 36 extends from the first support piece 35. The second support piece 36 extends from the tip end of the first support piece 35. The second support piece 36 extends perpendicularly from the first support piece 35. The second support piece 36 extends upward.

The frame 32 includes a mounting portion 37. The mounting portion 37 is a portion to which the first pump unit 82 is mounted. The mounting portion 37 includes a first mounting piece 38 and second mounting pieces 39. In one example, the mounting portion 37 includes one first mounting piece 38 and two second mounting pieces 39. The mounting portion 37 is positioned above the support portion 34.

The first mounting piece 38 extends from the support plate 33. The first mounting piece 38 extends perpendicularly from the support plate 33. The first mounting piece 38 extends so as to close the first pump unit 82. The second mounting piece 39 extends from the first mounting piece 38. The second mounting piece 39 extends from the tip end of the first mounting piece 38. The second mounting piece 39 extends perpendicularly from the first mounting piece 38. The second mounting piece 39 extends upward.

A fixing hole 40 opens in the mounting portion 37. The fixing hole 40 is a hole that vertically penetrates the mounting portion 37. The fixing hole 40 opens into the first mounting piece 38 as an opening. In one example, the fixing hole 40 is positioned between the two second mounting pieces 39. A fixing member 41 (to be described later) is inserted into the fixing hole 40. As a result, the first pump unit 82 is fixed to the mounting portion 37.

The liquid ejection device 11 includes a fixing member 41. The fixing member 41 is a member that fixes the liquid supply unit 30 to the frame 32. Specifically, the fixing member 41 fixes the pressure changing unit 81 to the frame 32. More specifically, the fixing member 41 fixes the pump unit to the frame 32. In one example, the fixing member 41 fixes the first pump unit 82 to the frame 32. The fixing member 41 is, for example, a screw.

The fixing member 41 is configured to be attachable to and detachable from with respect to the pressure changing unit 81 and the frame 32 from above. In one example, the fixing member 41 is inserted with respect to the fixing hole 40 from above. Therefore, the user can attach and detach the fixing member 41 from above. For example, when the reading section 14 is opened with respect to the housing 12, the fixing member 41 is exposed. Therefore, the user can remove the first pump unit 82 from above.

As shown in FIG. 2, the liquid ejection device 11 includes a control section 42. The control section 42 controls the liquid supply unit 30. The control section 42 may control the liquid ejection unit 22 in addition to the liquid supply unit 30. The control section 42 may integrally control the liquid ejection device 11.

The control section 42 may be configured by one or more processors that execute various processes in accordance with a computer program. The control section 42 may be configured by one or more dedicated hardware circuits such as an ASIC that executes at least a part of various processes. The control section 42 may be configured by a circuit including a combination of a processor and a hardware circuit. The processor includes a CPU and memory such as RAM and ROM. The memory stores program codes or instructions configured to cause the CPU to execute the processing. The memory, that is, computer-readable medium includes any readable medium that can be accessed by a general-purpose or dedicated computer.

### Flow Section

Next, the flow section 27 will be described.

The flow section 27 may include an adjustment valve 51. The adjustment valve 51 is configured to open and close. The adjustment valve 51 is normally closed. When the adjustment valve 51 is opened, the liquid can be supplied to the ejection section 23. By the adjustment valve 51 opening, the liquid flows into the flow section 27.

The adjustment valve 51 is configured to adjust the pressure in the ejection section 23. In one example, the adjustment valve 51 is configured to adjust the pressure in the flow section 27. By opening and closing based on the pressure in the flow section 27, the adjustment valve 51 adjusts the pressure in the flow section 27. By adjusting the pressure in the flow section 27, the adjustment valve 51 adjusts the pressure in the ejection section 23.

The adjustment valve 51 is configured to open and close by a differential pressure between the pressure in the ejection section 23 and the atmospheric pressure. In one example, the adjustment valve 51 is opened and closed by the differential pressure between the pressure in the flow section 27 and the atmospheric pressure. Specifically, when the pressure downstream of the adjustment valve 51 is equal to or lower than a predetermined pressure, the adjustment valve 51 opens. That is, when the pressure in the flow section 27 is equal to or lower than the predetermined pressure, the adjustment valve 51 opens. When the pressure in the flow section 27 is higher than the predetermined pressure, the adjustment valve 51 closes.

By opening and closing, the adjustment valve 51 maintains the inside of the flow section 27 at the predetermined pressure. By maintaining the inside of the flow section 27 at the predetermined pressure, the adjustment valve 51 maintains the inside of the ejection section 23 at the predetermined pressure. An operating pressure at which the adjustment valve 51 opens is a predetermined negative pressure. Therefore, the inside of the ejection section 23 is maintained at the predetermined negative pressure by the adjustment valve 51. By the inside of the ejection section 23 maintaining at the predetermined negative pressure, a meniscus is formed in the nozzle 25. By the meniscus forming in the nozzle 25, the ejection section 23 can eject the liquid well. In the liquid ejection device 11, the inside of the ejection section 23 may be maintained at a negative pressure not only by the adjustment valve 51 but also by, for example, a water head difference.

The flow section 27 includes one or more accommodation sections 28. The flow section 27 includes, for example, the opening and closing valve 52 and the pressurizing section 53. Each of the opening and closing valve 52 and the pressurizing section 53 is an example of the accommodation section 28. The opening and closing valve 52 and the pressurizing section 53 are positioned downstream of the adjustment valve 51. In the flow section 27, by passing through the adjustment valve 51, the opening and closing valve 52, and the pressurizing section 53 in this order, the liquid is supplied to the ejection section 23.

The opening and closing valve 52 is connected to the adjustment valve 51. The opening and closing valve 52 is connected to the pressurizing section 53. The opening and closing valve 52 is connected to the ejection section 23 through the pressurizing section 53. The opening and closing valve 52 is configured to open and close. The opening and closing valve 52, unlike the adjustment valve 51, is configured to open and close arbitrarily. By being controlled by the control section 42, the opening and closing valve 52 is opened and closed. By the pressure in the air chamber C2 of the opening and closing valve 52 changing, the opening and closing valve 52 opens and closes. When the ejection section 23 is cleaned, the opening and closing valve 52 closes. Specifically, when the pressurizing section 53 cleans the ejection section 23, the opening and closing valve 52 closes. The opening and closing valve 52 is normally open.

The pressurizing section 53 is connected to the ejection section 23. The pressurizing section 53 is configured to pressurize the inside of the ejection section 23. By the pressure in the air chamber C2 of the pressurizing section 53 changing, the pressurizing section 53 pressurizes the inside of the ejection section 23. By pressurizing the inside of the ejection section 23, the pressurizing section 53 cleans the ejection section 23. Specifically, by pressurizing the inside of the ejection section 23, the pressurizing section 53 discharges the liquid from the nozzle 25. As a result, thickened liquid, foreign matter, and the like are discharged from the ejection section 23. By the pressurizing section 53 pressurizing the inside of the ejection section 23 when the opening and closing valve 52 is closed, a concern that the liquid flows backward from the pressurizing section 53 is reduced. By the opening and closing valve 52 closing, that is, choking, the pressurizing section 53 can effectively pressurize the inside of the ejection section 23.

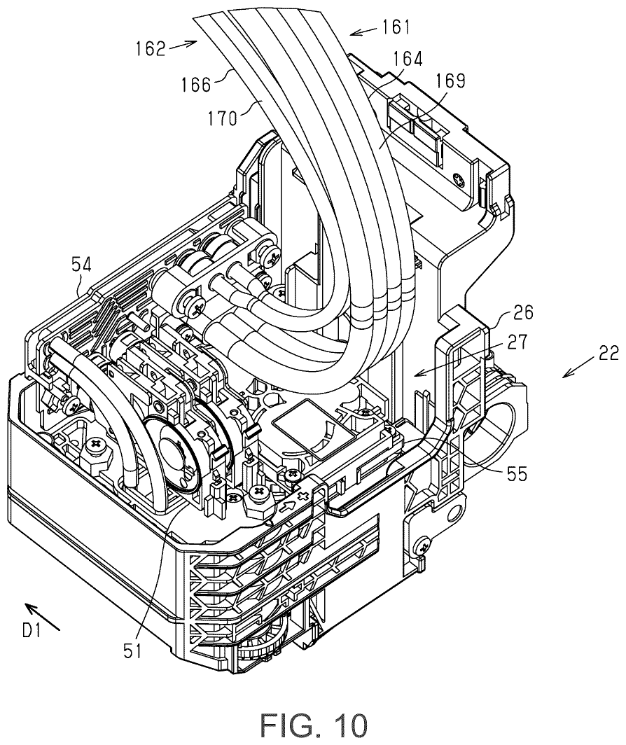

As shown in FIG. 10, the flow section 27 includes an ejection joint 54. The ejection joint 54 is connected to the adjustment valve 51. In one example, the ejection joint 54 is connected to the adjustment valve 51 through a tube. The ejection joint 54 is connected to the liquid supply unit 30. Specifically, the ejection joint 54 is connected to a supply flow path 161 (to be described later) and an air flow path 162 (to be described later). The liquid is supplied to the flow section 27 through the ejection joint 54 and the adjustment valve 51. Air is supplied into the flow section 27 through the ejection joint 54.

The flow section 27 includes a flow member 55. The flow member 55 is a member that defines a space for containing the liquid. The flow member 55 also defines a space for containing air. The flow member 55 constitutes the opening and closing valve 52 and the pressurizing section 53. The flow member 55 is connected to the adjustment valve 51. The flow member 55 is connected to the ejection joint 54. The flow member 55 is supplied with the liquid through the adjustment valve 51 and the ejection joint 54. Air is supplied into the flow member 55 through the ejection joint 54. The flow member 55 may constitute the adjustment valve 51 in addition to the opening and closing valve 52 and the pressurizing section 53. The flow member 55 may further constitute the ejection joint 54. That is, the adjustment valve 51, the opening and closing valve 52, the pressurizing section 53, and the ejection joint 54 may be integrally configured by the flow member 55.

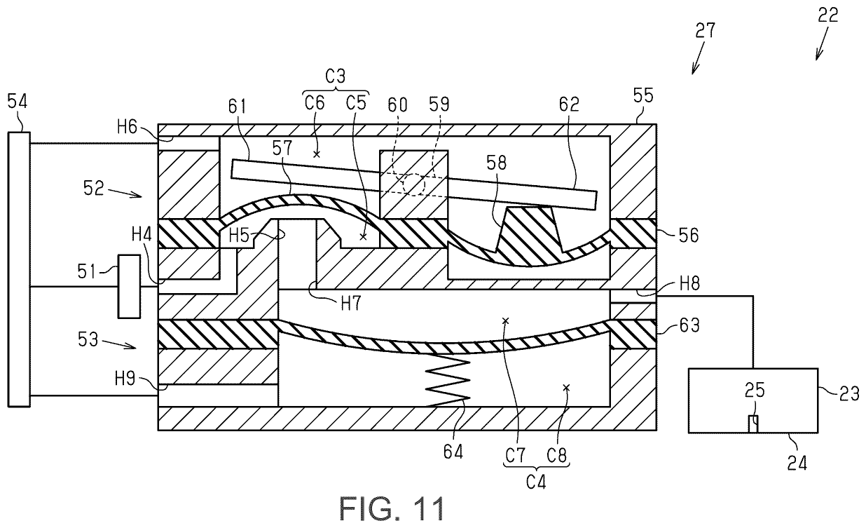

As shown in FIG. 11, the flow member 55 defines a choke space C3. The choke space C3 is a space in the opening and closing valve 52. A choke inflow port H4 and a choke outflow port H5 open in the flow member 55. The choke inflow port H4 is an example of the inflow port H1. The choke inflow port H4 communicates with the adjustment valve 51. The choke outflow port H5 is an example of the outflow port H2. The choke outflow port H5 communicates with the pressurizing section 53. A choke air port H6 opens in the flow member 55. The choke air port H6 is an example of the air port H3. The choke air port H6 communicates with the ejection joint 54.

The flow member 55 defines a pressurizing space C4. The pressurizing space C4 is a space in the pressurizing section 53. A pressurized inflow port H7 and a pressurized outflow port H8 open in the flow member 55. The pressurized inflow port H7 is an example of the inflow port H1. The pressurized inflow port H7 communicates with the opening and closing valve 52. The pressurized inflow port H7 is a common opening with the choke outflow port H5. The pressurized outflow port H8 is an example of the outflow port H2. The pressurized outflow port H8 communicates with the ejection section 23. A pressurized air port H99 opens in the flow member 55. The pressurized air port H9 is an example of the air port H3. The pressurized air port H9 communicates with the ejection joint 54.

The flow section 27 includes a choke membrane 56. The choke membrane 56 is mounted to the flow member 55. The choke membrane 56 is an example of a membrane member 29. The choke membrane 56 constitutes the opening and closing valve 52. The choke membrane 56 divides the choke space C3 into a choke liquid chamber C5 and a choke air chamber C6. The choke liquid chamber C5 is an example of the liquid chamber C1. The choke liquid chamber C5 communicates with the choke inflow port H4 and the choke outflow port H5. The choke air chamber C6 is an example of the air chamber C2. The choke air chamber C6 communicates with the choke air port H6.

The choke membrane 56 includes a valve portion 57. The valve portion 57 is a portion that closes the choke inflow port H4 or the choke outflow port H5. In one example, the valve portion 57 closes choke outflow port H5. By being pressed against a lever 59 (to be described later), the valve portion 57 closes the choke outflow port H5.

The choke membrane 56 includes a motion portion 58. The motion portion 58 is a portion for operating the lever 59. The motion portion 58 is configured to be more deformable than the valve portion 57. In one example, the motion portion 58 is configured to have less elasticity than the valve portion 57. For example, the thickness of the motion portion 58 may be smaller than the thickness of the valve portion 57. The area facing the choke air chamber C6 in the motion portion 58 may be larger than the area facing the choke air chamber C6 in the valve portion 57.

When the choke air chamber C6 is decompressed, the valve portion 57 and the motion portion 58 are deformed so as to reduce the volume of the choke air chamber C6. At this time, the motion portion 58 is more easily deformed as compared with the valve portion 57.

The flow section 27 includes the lever 59. The lever 59 constitutes an opening and closing valve 52. The lever 59 is mounted to the flow member 55. The lever 59 is positioned in the choke space C3. Specifically, the lever 59 is positioned in the choke air chamber C6.

The lever 59 includes, for example, a shaft portion 60. The shaft portion 60 is mounted to the flow member 55. The lever 59 is displaced around the shaft portion 60. The lever 59 is displaced in the choke air chamber C6.

The lever 59 includes a first portion 61 and a second portion 62. The first portion 61 is a portion including one end of the lever 59. The first portion 61 is positioned so as to be in contact with the valve portion 57. The second portion 62 is a portion including the other end of the lever 59. The second portion 62 is positioned so as to be in contact with the motion portion 58.

When the choke air chamber C6 is depressurized, the valve portion 57 is deformed so as to push up the first portion 61. When the choke air chamber C6 is decompressed, the motion portion 58 is deformed so as to push up the second portion 62. Since the motion portion 58 is more deformable than the valve portion 57, the force by which the motion portion 58 pushes up the lever 59 is greater than the force by which the valve portion 57 pushes up the lever 59. Therefore, the lever 59 is displaced so that the first portion 61 pushes down the valve portion 57. That is, the lever 59 presses the valve portion 57 against the choke outflow port H5. As a result, the choke outflow port H5 is closed.

The flow section 27 includes a pressurizing membrane 63. The pressurizing membrane 63 is mounted to the flow member 55. The pressurizing membrane 63 is an example of the membrane member 29. The pressurizing membrane 63 constitutes the pressurizing section 53. The pressurizing membrane 63 divides the pressurizing space C4 into a pressurizing liquid chamber C7 and a pressurizing air chamber C8. The pressurizing liquid chamber C7 is an example of the liquid chamber C1. The pressurizing liquid chamber C7 communicates with the pressurized inflow port H7 and the pressurized outflow port H8. The pressurizing air chamber C8 is an example of the air chamber C2. The pressurizing air chamber C8 communicates with the pressurized air port H9.

The flow section 27 may include a pressurizing member 64. The pressurizing member 64 is configured to press the pressurizing membrane 63. Specifically, the pressurizing member 64 presses the pressurizing membrane 63 so as to reduce the volume of the pressurizing liquid chamber C7. The pressurizing member 64 is positioned in the pressurizing air chamber C8. The pressurizing member 64 is mounted to the flow member 55 and the pressurizing membrane 63.

When the pressurizing air chamber C8 is depressurized, the pressurizing membrane 63 is displaced so that the volume of the pressurizing air chamber C8 is reduced. At this time, the pressurizing membrane 63 is displaced so as to increase the volume of the pressurizing liquid chamber C7. As a result, the liquid flows into the pressurizing liquid chamber C7. Specifically, the liquid flows from the ejection section 23, the adjustment valve 51, the opening and closing valve 52, and the like into the pressurizing liquid chamber C7. When the pressurizing air chamber C8 is pressurized or opened to the atmosphere, the pressurizing membrane 63 is deformed so that the volume of the pressurizing liquid chamber C7 is reduced. At this time, the liquid in the pressurizing liquid chamber C7 is pressurized. As a result, the liquid is discharged from the nozzle 25.

### Liquid Supply Unit

Next, the liquid supply unit 30 will be described.

As shown in FIG. 4, FIG. 5, FIG. 6, and FIG. 7, the liquid supply unit 30 is connected to the mount section 18. The liquid supply unit 30 is connected to the liquid ejection unit 22.

The liquid supply unit 30 includes the accommodation section 28. Specifically, the liquid supply unit 30 includes the flow path pump 71. The flow path pump 71 is an example of the accommodation section 28. The flow path pump 71 is a so-called diaphragm pump.

The liquid supply unit 30 includes one or more flow path pumps 71. In one example, the liquid supply unit 30 includes four flow path pumps 71s. The flow path pump 71 is connected to mount section 18. The flow path pump 71 is positioned behind the mount section 18. Four flow path pumps 71 are respectively positioned behind the four liquid accommodation bodies 20. The flow path pump 71 is connected to the liquid accommodation body 20 through the mount section 18. Four flow path pumps 71 are respectively connected to the four liquid accommodation bodies 20. The flow path pump 71 supplies the liquid from the liquid accommodation body 20 toward the ejection section 23.

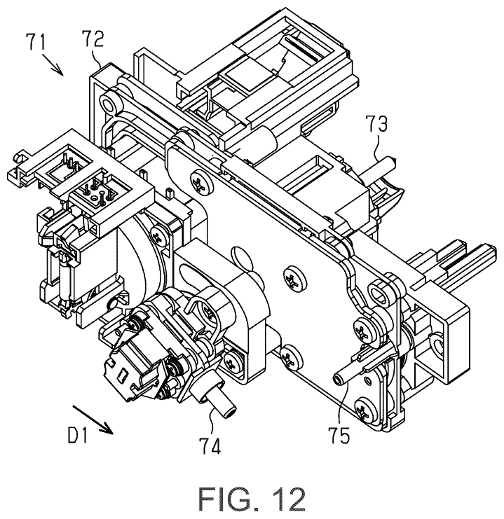

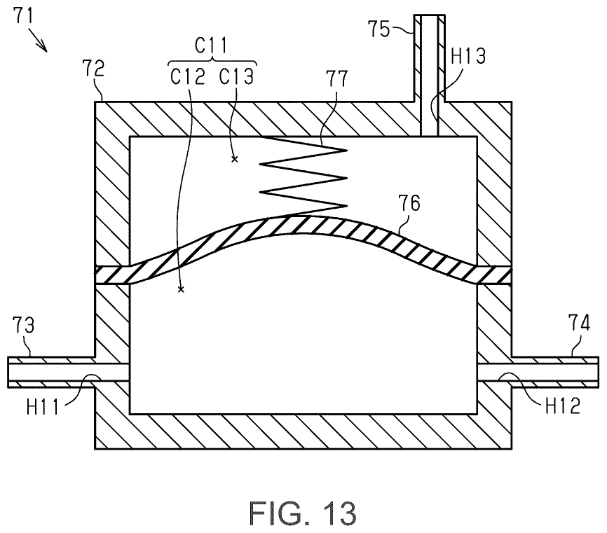

As shown in FIG. 12 and FIG. 13, the flow path pump 71 includes a pump member 72. The pump member 72 defines a pump space C11. The pump member 72 includes a pump inflow pipe 73, a pump outflow pipe 74, and a pump air pipe 75. The pump inflow pipe 73 is inserted into the liquid accommodation body 20 mounted on the mount section 18. The pump inflow pipe 73 is a so-called supply needle. A pump inflow port H11 opens in the pump inflow pipe 73. The pump inflow port H11 is an example of the inflow port H1. The pump outflow pipe 74 is connected to the supply flow path 161. A pump outflow port H12 opens in the pump outflow pipe 74. The pump outflow port H12 is an example of the outflow port H2. The pump air pipe 75 is connected to the air flow path 162. A pump air port H13 opens in the pump air pipe 75. The pump air port H13 is an example of the air port H3.

As shown in FIG. 13, The flow path pump 71 includes a diaphragm 76, which is an example of the membrane member 29. The diaphragm 76 divides the flow path pump 71 into a pump liquid chamber C12 and a pump air chamber C13. Specifically, the diaphragm 76 divides the pump space C11 into the pump liquid chamber C12 and the pump air chamber C13. The pump liquid chamber C12 is an example of the liquid chamber C1. The pump air chamber C13 is an example of the air chamber C2. The pump liquid chamber C12 communicates with the pump inflow port H11 and the pump outflow port H12. The pump liquid chamber C12 communicates with the ejection section 23 through the pump outflow port H12. The pump air chamber C13 communicates with the pump air port H13. The pump air chamber C13 communicates with the pressure changing unit 81 through the pump air port H13.

The flow path pump 71 includes a pressing member 77. The pressing member 77 is configured to press the diaphragm 76. Specifically, the pressing member 77 presses the diaphragm 76 so as to reduce the volume of the pump liquid chamber C12. That is, the pressing member 77 presses the diaphragm 76 so as to pressurize the pump liquid chamber C12. The pressing member 77 is positioned in the pump air chamber C13.

When the pump air chamber C13 is depressurized, the diaphragm 76 deforms so as to increase the volume of the pump liquid chamber C12. As a result, the liquid flows from the liquid accommodation body 20 into the pump liquid chamber C12. When the pump air chamber C13 is pressurized or opened to the atmosphere, the diaphragm 76 is deformed so that the volume of the pump liquid chamber C12 is reduced. As a result, the liquid flows out from the pump liquid chamber C12 toward the flow section 27.

As shown in FIG. 4, FIG. 5, FIG. 6, and FIG. 7, the liquid supply unit 30 includes the pressure changing unit 81. The pressure changing unit 81 is connected to a plurality of connect destinations. The plurality of connect destinations include one or more accommodation sections 28. That is, the pressure changing unit 81 is connected to one or more accommodation sections 28. In one example, the plurality of connect destinations include the plurality of accommodation sections 28. The pressure changing unit 81 is connected to the plurality of accommodation sections 28. Specifically, the pressure changing unit 81 is connected to the opening and closing valve 52, the pressurizing section 53, and the flow path pump 71. The plurality of connect destinations may include a configuration other than the accommodation section 28. That is, the pressure changing unit 81 may be connected to a configuration other than the accommodation section 28.

The pressure changing unit 81 is configured to change the pressures of the plurality of connect destinations. Specifically, the pressure changing unit 81 changes the pressure of one or more connect destinations among the plurality of connect destinations. The pressure changing unit 81 changes the pressure of an arbitrary connect destination among the plurality of connect destinations. For example, the pressure changing unit 81 changes the pressure of the accommodation section 28 among the plurality of connect destinations. The pressure changing unit 81 changes the pressure of the opening and closing valve 52, the pressurizing section 53, the flow path pump 71, and the like.

The pressure changing unit 81 changes the pressure in the air chamber C2. In one example, the pressure changing unit 81 depressurizes the air chamber C2. The pressure changing unit 81 may pressurize the air chamber C2.

The pressure changing unit 81 selectively changes the pressure of the plurality of accommodation sections 28. For example, the pressure changing unit 81 changes the pressure of an arbitrary accommodation section 28 among the opening and closing valve 52, the pressurizing section 53, and the flow path pump 71. The pressure changing unit 81 selectively changes the pressures in the air chamber C2. That is, the pressure changing unit 81 selectively varies the pressures of the choke air chamber C6, the pressurizing air chamber C8, and the pump air chamber C13.

The pressure changing unit 81 includes one or more pump units. In one example, the pressure changing unit 81 includes the first pump unit 82 and a second pump unit 83. The first pump unit 82 and the second pump unit 83 are respectively connected to the plurality of connect destinations. The connect destination of the first pump unit 82 and the connect destination of the second pump unit 83 are common. That is, the first pump unit 82 and the second pump unit 83 are connected to the opening and closing valve 52, the pressurizing section 53, and the flow path pump 71. By sucking air from the connect destination or discharging air to the connect destination, the first pump unit 82 and the second pump unit 83 change the pressure of the connect destination. When the pressure changing unit 81 includes a plurality of pump units, it is easy to change the pressure at the connect destination.

The first pump unit 82 is mounted to the frame 32. The first pump unit 82 is fixed to the frame 32. The second pump unit 83 is mounted to mount section 18. The second pump unit 83 is fixed to the mount section 18. The second pump unit 83 is positioned behind the mount section 18. The first pump unit 82 is positioned higher than the second pump unit 83.

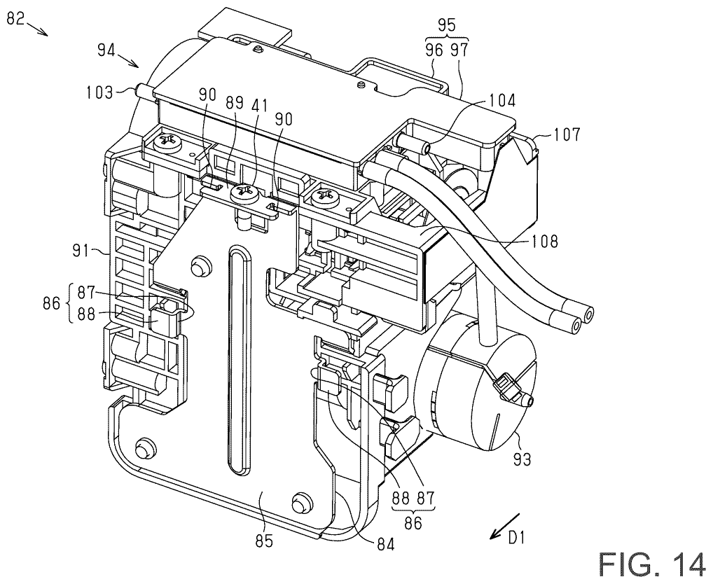

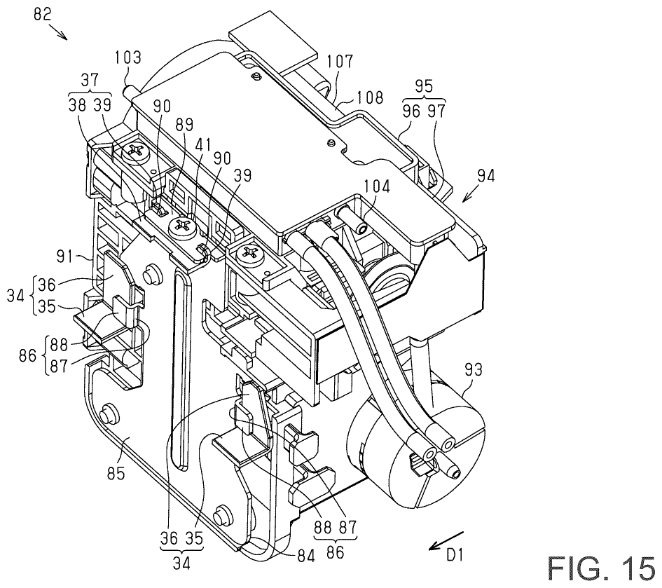

As shown in FIG. 14 and FIG. 15, the first pump unit 82 includes a mounting member 84. The mounting member 84 is a member mounted to the frame 32. The mounting member 84 is fixed to the frame 32.

The mounting member 84 includes a mounting plate 85. The mounting plate 85 faces the support plate 33. The mounting plate 85 extends so as to along the support plate 33. The mounting plate 85 extends in a direction perpendicular to the scanning direction D1.

The mounting member 84 includes one or more contact portions 86. In one example, the mounting member 84 includes two contact portions 86. The contact portion 86 extends from the mounting plate 85. The contact portion 86 is the portion that is in contact with the support portion 34.

The contact portion 86 includes a first contact piece 87 and a second contact piece 88. The first contact piece 87 extends from the mounting plate 85. The first contact piece 87 extends toward the support plate 33. The first contact piece 87 extends perpendicularly to the mounting plate 85. The second contact piece 88 extends from the first contact piece 87. The second contact piece 88 extends from the tip end of the first contact piece 87. The second contact piece 88 extends perpendicularly from the first contact piece 87. Two second contact pieces 88 extend away from each other.

The contact portion 86 is mounted to the support portion 34. Specifically, by the second contact piece 88 being hooked on the support portion 34, the contact portion 86 is mounted to the support portion 34. For example, by the support portion 34 inserting with respect to the contact portion 86 from below, the contact portion 86 is hooked on the support portion 34. At this time, the second contact piece 88 is positioned between the support plate 33 and the second support piece 36. As a result, the first pump unit 82 is supported by the frame 32.

The mounting member 84 includes an inserting portion 89. The inserting portion 89 extends from the mounting plate 85. The inserting portion 89 extends towards the support plate 33. The inserting portion 89 extends perpendicularly to the mounting plate 85. The inserting portion 89 is a portion into which the fixing member 41 is inserted. The inserting portion 89 is, for example, positioned above the contact portion 86.

One or more inserting grooves 90 are formed in the inserting portion 89. In one example, two inserting grooves 90 are formed in the inserting portion 89. The mounting portion 37 is inserted into the inserting grooves 90. Specifically, the second mounting pieces 39 are inserted into the inserting grooves 90. The second mounting pieces 39 are inserted into the inserting grooves 90 from below. By the mounting portion 37 inserting into the inserting grooves 90, the inserting portion 89 is mounted to the mounting portion 37.

By the contact portion 86 and the inserting portion 89 mounting to the frame 32, the posture of the first pump unit 82 is stabilized. Since the first pump unit 82 is supported by the support portion 34 at the two points of the contact portion 86 and the inserting portion 89, the rattling of the first pump unit 82 is reduced.

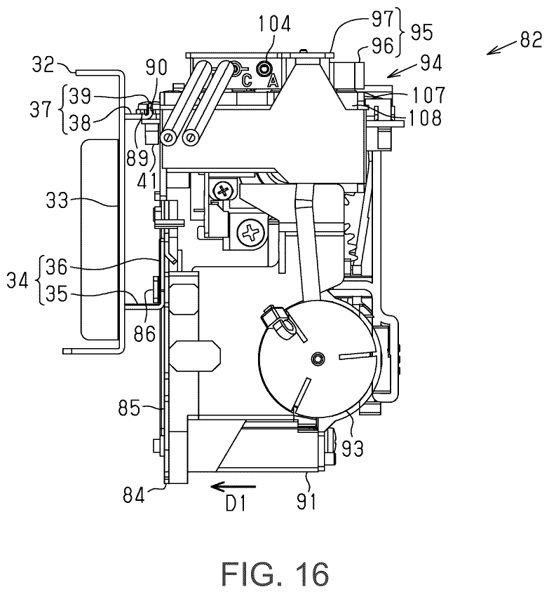

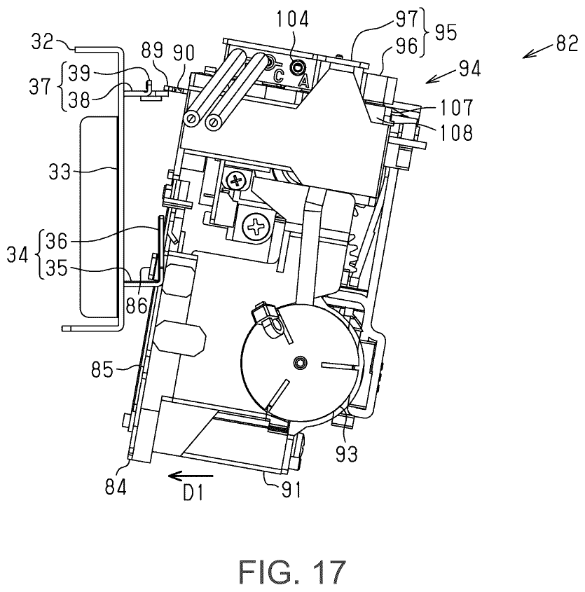

As shown in FIG. 16 and FIG. 17, by the first pump unit 82 lifting upward, the contact portion 86 is removed from the support portion 34. By the first pump unit 82 lifting upward, the inserting portion 89 is removed from the mounting portion 37. As a result, the first pump unit 82 is removed from the frame 32. When the first pump unit 82 is mounted on the frame 32, the support portion 34 is inserted into the contact portion 86 and the mounting portion 37 is inserted into the inserting portion 89. In this way, the first pump unit 82 is configured to be easily attached and detached from above. As a result, maintainability of the pressure changing unit 81 is improved.

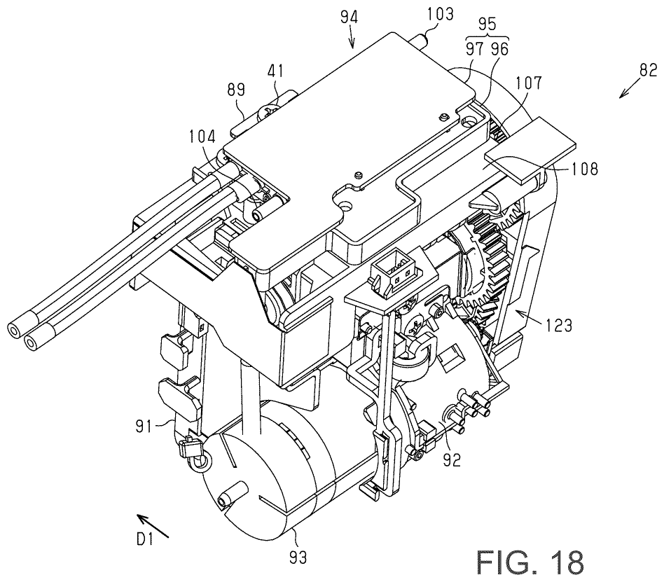

As shown in FIG. 18, the first pump unit 82 includes a base member 91. Various components of the first pump unit 82 are mounted to the base member 91. The mounting member 84 is mounted to the base member 91.

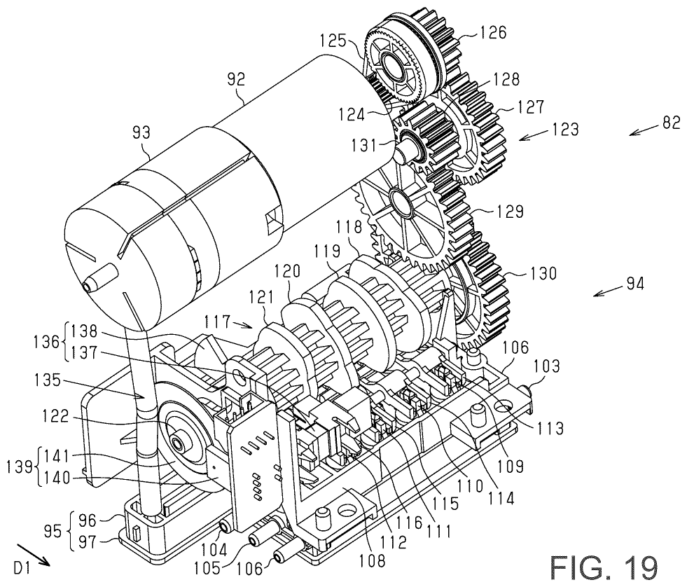

As shown in FIG. 18 and FIG. 19, the first pump unit 82 includes a motor. Specifically, the first pump unit 82 includes a first motor 92. The first motor 92 is configured to rotate in the forward direction and reverse direction. In one example, the first motor 92 is configured to be capable of extracting power from both shafts.

The first pump unit 82 includes a pump. Specifically, the first pump unit 82 includes a first pump 93. The first pump 93 changes the pressure of the accommodation section 28. In one example, the first pump 93 is a decompression pump. The first pump 93 may be a pressurization pump.

The first pump 93 is connected to the first motor 92. The first pump 93 is driven by the power of the first motor 92. By the first motor 92 is driven, the first pump 93 is driven. In one example, both when the first motor 92 is in a forward rotation and when the first motor 92 is in a reverse rotation, the first pump 93 is driven so as to generate a negative pressure.

The first pump 93 is connected to the plurality of connect destinations of the pressure changing unit 81. In one example, the first pump 93 is connected to the accommodation section 28. Specifically, the first pump 93 is connected to the opening and closing valve 52, the pressurizing section 53, and the flow path pump 71.

The first pump unit 82 includes a switching section 94. The switching section 94 is configured to switch the connection between the first pump 93 and the plurality of connect destinations of the first pump unit 82. The switching section 94 switches the connection so as to change the pressure of an arbitrary connect destination among the plurality of connect destinations. It can also be said that the switching section 94 switches the path connecting the connect destination and the first pump 93. In one example, the switching section 94 switches the connection between the plurality of accommodation sections 28 and the first pump 93.

The switching section 94 is connected to the first motor 92. the switching section 94 switches the plurality of connect destinations of the first pump unit 82 and the connection between the first pump 93 by the power of the first motor 92. That is, the switching section 94 switches the path connecting the accommodation section 28 and the first pump 93 by the power of the first motor 92. The switching section 94 causes the negative pressure by the first pump 93 to act on an arbitrary accommodation section 28.

The switching section 94 includes a flow path member 95. The flow path member 95 is connected to the first pump 93. Air flows through the flow path member 95. The negative pressure of the first pump 93 acts on the accommodation section 28 through the flow path member 95.

The flow path member 95 includes a flow path substrate 96 and a cover member 97. The flow path substrate 96 is bonded to the cover member 97. For example, the flow path substrate 96 is laser-welded to the cover member 97. The flow path substrate 96 may be thermally welded to the cover member 97, or may be bonded to the cover member 97 with an adhesive.

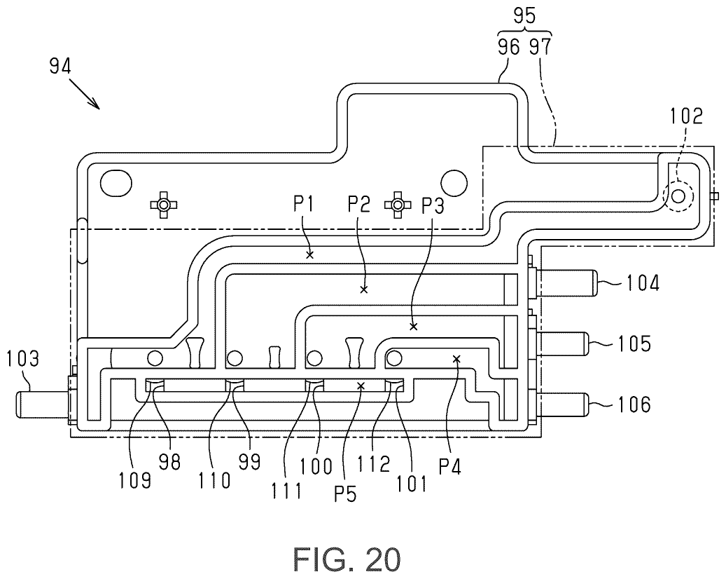

As shown in FIG. 20, a plurality of switching paths are defined in the flow path member 95. In one example, in the flow path member 95, a pump path P1, a reverse path P2, a pressurized path P3, a choke path P4, and a connection path P5 are defined. The pump path P1 is a flow path communicating with the first pump 93. The pump path P1 is a flow path communicating with the flow path pump 71. The reverse path P2 is a flow path communicating with the atmosphere. The pressurized path P3 is a flow path communicating with the pressurizing section 53. The choke path P4 is a flow path communicating with the opening and closing valve 52. The connection path P5 is a flow path communicating with each of the pump path P1, the reverse path P2, the pressurized path P3, and the choke path P4.

A plurality of switching ports open in the flow path member 95. The switching port is an opening through which the switching paths communicate with each other. In one example, a pump port 98, a release port 99, a pressurizing port 100, and a choke port 101 open in the flow path substrate 96. The pump port 98 causes the pump path P1 to communicate with the connection path P5. The release port 99 causes the reverse path P2 to communicate with the connection path P5. The pressurizing port 100 causes the pressurized path P3 to communicate with the connection path P5. The choke port 101 causes the choke path P4 to communicate with the connection path P5.

The first pump 93 is open to the atmosphere by the pump port 98 and the release port 99. The first pump 93 communicates with the pressurizing section 53 by the pump port 98 and the pressurizing port 100. The first pump 93 communicate with the opening and closing valve 52 by the pump port 98 and the choke port 101.

The flow path member 95 includes a plurality of connection tubes. The connection tube is a tube through which air enters and exits the flow path member 95. In one example, the flow path member 95 includes a pump pipe 102, a flow path pump pipe 103, a release tube 104, a pressurizing tube 105, and a choke tube 106. The pump pipe 102 communicates with the pump path P1. The pump pipe 102 is connected to the first pump 93. The pump pipe 102 is connected to the first pump 93 through, for example, a tube. The flow path pump pipe 103 communicates with the pump path P1. The flow path pump pipe 103 is connected to the flow path pump 71 through, for example, a tube. The release tube 104 communicates with the reverse path P2. The release tube 104 is open to the atmosphere. The pressurizing tube 105 communicates with the pressurized path P3. The pressurizing tube 105 is connected to the pressurizing section 53 through, for example, a tube. The choke tube 106 communicates with the choke path P4. The choke tube 106 is connected to the opening and closing valve 52 through, for example, a tube.

As shown in FIG. 19, the switching section 94 includes a selector valve 107. The selector valve 107 is configured to open and close the plurality of switching paths. The selector valve 107 opens an arbitrary switching path among the plurality of switching paths. In one example, the selector valve 107 opens an arbitrary switching path among the pump path P1, the reverse path P2, the pressurized path P3, and the choke path P4. As a result, the selector valve 107 allows the first pump 93 to communicate with an arbitrary accommodation section 28.

The selector valve 107 includes a valve base 108. The valve base 108 is mounted to the flow path member 95. Specifically, the valve base 108 is mounted to the flow path substrate 96.

The selector valve 107 includes a plurality of valves. In one example, selector valve 107 includes a pump valve 109, a release valve 110, a pressurizing valve 111, and a choke valve 112. The plurality of valves are mounted to the valve base 108. The pump valve 109, the release valve 110, the pressurizing valve 111, and the choke valve 112 are mounted to the valve base 108.

The plurality of valves are positioned between the plurality of connect destinations and the first pump 93. Specifically, the plurality of valves are positioned in a path connecting the connect destination and the first pump 93. The plurality of valves open and close this path. In one example, the plurality of valves open and close the switching ports.

As shown in FIG. 20, the pump valve 109 is positioned so as to close the pump port 98. The pump valve 109 opens and closes the pump port 98. The release valve 110 is positioned so as to close the release port 99. The release valve 110 opens and closes the release port 99. The pressurizing valve 111 is positioned so as to close the pressurizing port 100. The pressurizing valve 111 opens and closes the pressurizing port 100. The choke valve 112 is positioned so as to close the choke port 101. The choke valve 112 opens and closes the choke port 101.

As shown in FIG. 19, the selector valve 107 includes a plurality of valve levers. In one example, the selector valve 107 includes a pump valve lever 113, a release valve lever 114, a pressurizing valve lever 115, and a choke valve lever 116. The valve lever is a lever for opening the valve. The valve lever is connected to the valve. The valve lever is mounted to the valve base 108.

The pump valve lever 113 is connected to the pump valve 109. The pump valve lever 113 lifts the pump valve 109. As a result, the pump valve 109 is opened. That is, the pump port 98 is opened.

The release valve lever 114 is connected to the release valve 110. The release valve lever 114 lifts the release valve 110. As a result, the release valve 110 is opened. That is, release port 99 is opened.

The pressurizing valve lever 115 is connected to the pressurizing valve 111. The pressurizing valve lever 115 lifts the pressurizing valve 111. As a result, the pressurizing valve 111 is opened. That is, the pressurizing port 100 is opened.

The choke valve lever 116 is connected to the choke valve 112. The choke valve lever 116 lifts the choke valve 112. As a result, the choke valve 112 is opened. That is, the choke port 101 is opened.

The switching section 94 includes a cam unit 117. The cam unit 117 is a unit that operates the valve lever. The cam unit 117 arbitrarily operates the pump valve lever 113, the release valve lever 114, the pressurizing valve lever 115, and the choke valve lever 116. That is, the cam unit 117 causes the pump valve 109, the release valve 110, the pressurizing valve 111, and the choke valve 112 to arbitrarily open.

The cam unit 117 includes a plurality of cams. In one example, the cam unit 117 includes a pump cam 118, a release cam 119, a pressurizing cam 120, and a choke cam 121. The plurality of cams cause the plurality of valves to open and close. The pump cam 118 causes the pump valve 109 to open and close. The release cam 119 causes the release valve 110 to open and close. The pressurizing cam 120 causes the pressurizing valve 111 to open and close. The choke cam 121 causes the choke valve 112 to open and close.

The cam contacts the valve lever. By rotating, the cam pushes down the valve lever. As a result, the valve is opened. If the cam does not push the valve lever down, the valve lever will not lift the valve. When the valve lever does not lift the valve, the valve closes the switching port by its own weight or spring action.

The pump cam 118 contacts the pump valve lever 113. By rotating, The pump cam 118 pushes down the pump valve lever 113. As a result, the pump valve 109 opens the pump port 98.

The release cam 119 contacts the release valve lever 114. By rotating, The release cam 119 pushes down the release valve lever 114. As a result, the release valve 110 opens the release port 99.

The pressurizing cam 120 contacts the pressurizing valve lever 115. By rotating, the pressurizing cam 120 pushes down the pressurizing valve lever 115. As a result, the pressurizing valve 111 opens the pressurizing port 100.

The choke cam 121 contacts the choke valve lever 116. By rotating, the choke cam 121 pushes down the choke valve lever 116. As a result, the choke valve 112 opens the choke port 101.

The cam unit 117 includes a camshaft 122. The camshaft 122 is the rotational axis of the cam. Specifically, the camshaft 122 is the rotational shaft for the pump cam 118, the release cam 119, the pressurizing cam 120, and the choke cam 121. As the camshaft 122 rotates, the pump cam 118, the release cam 119, the pressurizing cam 120, and the choke cam 121 rotate. Therefore, the rotation angle of the camshaft 122 corresponds to the opening and closing of the pump valve 109, the opening and closing of the release valve 110, the opening and closing of the pressurizing valve 111, and the opening and closing of the choke valve 112.

The first pump unit 82 includes a transmission section. Specifically, the first pump unit 82 includes a first transmission section 123. The first transmission section 123 is positioned between the first motor 92 and the switching section 94. Specifically, the first transmission section 123 is positioned between the first motor 92 and the switching section 94 in the path through which the power of the first motor 92 is transmitted.

The first transmission section 123 is configured to transmit the power of the first motor 92 to the switching section 94. Specifically, the first transmission section 123 transmits the power of the first motor 92 to the camshaft 122. The first transmission section 123 rotates the camshaft 122 by the power of the first motor 92. As a result, the plurality of cams are rotated.

The first transmission section 123 is configured to, when the first motor 92 rotates in the reverse direction, transmit the power of the first motor 92 to the switching section 94. That is, when the first motor 92 rotates in the reverse rotation, the first transmission section 123 rotates the camshaft 122 by the power of the first motor 92.

The first transmission section 123 is configured not to, when the first motor 92 rotates in the forward direction, transmit the power of the first motor 92 to the switching section 94. That is, when the first motor 92 rotates in the forward rotation, the first transmission section 123 does not rotate the camshaft 122.

The first transmission section 123 rotates the camshaft 122 only in one direction. By the first transmission section 123, when the first motor 92 rotates in the reverse rotation, the cam rotates and when the first motor 92 rotates in the forward rotation, the cam does not rotate. In this way, in the first pump unit 82, by the first motor 92, the first pump 93 can be driven and the switching section 94 can be driven.

The first transmission section 123 includes an output pinion 124. The output pinion 124 is mounted to the first motor 92. Specifically, the output pinion 124 is mounted to the shaft of the first motor 92.

The first transmission section 123 includes an output belt 125. The output belt 125 is wound around the output pinion 124. The output belt 125 rotates together with the output pinion 124. The output belt 125 transmits the torque of the output pinion 124.

The first transmission section 123 includes a plurality of gears. In one example, the first transmission section 123 includes an output gear 126, a transmission gear 127, a connection gear 128, a relay gear 129, and a cam gear 130.

The output gear 126 is connected to the output pinion 124. Specifically, the output belt 125 is wound around the output gear 126. Via the output belt 125, the output gear 126 is connected to the output pinion 124. The output gear 126 rotates together with the output pinion 124. The output gear 126 may be positioned to directly mesh with the output pinion 124.

The transmission gear 127 is connected to the output gear 126. The transmission gear 127 rotates together with the output gear 126. The transmission gear 127 is supported by a transmission shaft 131 (to be described later).

The connection gear 128 is connected to the transmission gear 127. The connection gear 128 is supported by the transmission shaft 131. That is, the connection gear 128 is positioned coaxially with the transmission gear 127. The connection gear 128 rotates together with the transmission shaft 131.

The relay gear 129 is connected to the connection gear 128. The relay gear 129 meshes with the connection gear 128. The relay gear 129 rotates together with the connection gear 128.

The cam gear 130 is connected to the relay gear 129. The cam gear 130 meshes with the relay gear 129. The cam gear 130 rotates together with the relay gear 129.

The first transmission section 123 includes the transmission shaft 131. The transmission shaft 131 transmits the torque of the transmission gear 127 to the connection gear 128. The transmission shaft 131 rotates as the transmission gear 127 rotates. Specifically, when the first motor 92 rotates in the reverse direction, the transmission shaft 131 rotates together with the transmission gear 127. When the first motor 92 rotates in the forward direction, the transmission shaft 131 does not rotate.

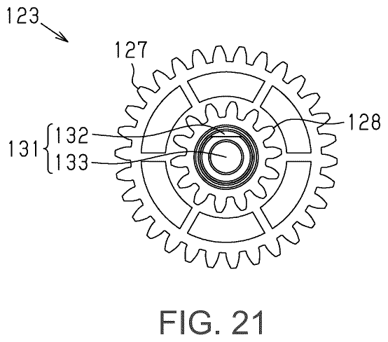

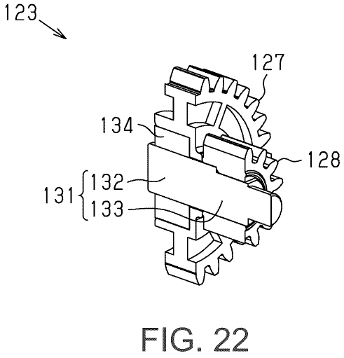

As shown in FIG. 21 and FIG. 22, the transmission shaft 131 includes a transmission support portion 132 and a connection support portion 133. The transmission support portion 132 is a portion that supports the transmission gear 127. The transmission support portion 132 is inserted into the transmission gear 127. The connection support portion 133 is a portion that supports the connection gear 128. The connection support portion 133 is inserted into the connection gear 128. In one example, the connection support portion 133 has a smaller diameter than the transmission support portion 132.

As viewed from the axial direction of the transmission shaft 131, the connection support portion 133 has a D-shape. The shaft hole of the connection gear 128 has a corresponding shape. As a result, the connection gear 128 rotates integrally with the transmission shaft 131.

As shown in FIG. 22, the first transmission section 123 includes a one way clutch 134. The one way clutch 134 is configured to, when the first motor 92 rotates in the reverse direction, transmit power. For example, the one way clutch 134 is mounted to the transmission gear 127. The one way clutch 134 is supported by the transmission shaft 131 together with the transmission gear 127. When the first motor 92 rotates in the reverse rotation direction, the one way clutch 134 transmits power from the transmission gear 127 to the transmission shaft 131. For example, when the first motor 92 rotates in the reverse rotation, the one way clutch 134 rotates together with the transmission gear 127. As the one way clutch 134 rotates, the transmission shaft 131 rotates.

When the first motor 92 rotates in the forward direction, the one way clutch 134 does not transmit power from the transmission gear 127 to the transmission shaft 131. For example, when the first motor 92 rotates in the forward rotation, the one way clutch 134 does not rotate with respect to the transmission gear 127. That is, when the first motor 92 rotates in the forward rotation, the one way clutch 134 remains stationary. Therefore, when the first motor 92 rotates in the forward rotation, the power is not transmitted to the switching section 94.

When the transmission gear 127 rotates in a direction corresponding to the reverse rotation of the first motor 92, the one way clutch 134 rotates together with the transmission gear 127. The one way clutch 134 is not limited to the transmission gear 127 and may be mounted to other gears.

As shown in FIG. 19, the first pump unit 82 includes a detection section 135. The detection section 135 is configured to detect the rotation angle of the first motor 92. In one example, the detection section 135 detects the rotation angle of the camshaft 122. The detection section 135 detects the rotation angle of the first motor 92 based on the rotation angle of the camshaft 122. The phase of the cam is precisely controlled by detection section 135.

The detection section 135 includes a photosensor unit 136. The photosensor unit 136 detects the rotation angle of the first motor 92. In one example, the photosensor unit 136 detects the rotation angle of the camshaft 122. Specifically, the photosensor unit 136 detects the reference angle of camshaft 122.

The photosensor unit 136 includes a photo interrupter 137 and a shield plate 138. The photo interrupter 137 is mounted to the valve base 108. The photo interrupter 137 detects the shield plate 138. The shield plate 138 is mounted to the camshaft 122. The shield plate 138 rotates together with the camshaft 122. The shield plate 138 passes through the inside of the photo interrupter 137 in the process of rotating. At this time, the shield plate 138 is detected by the photo interrupter 137. By the photo interrupter 137 detecting the shield plate 138, the rotation angle of the camshaft 122 is detected. Specifically, the reference angle of camshaft 122 is detected.

The detection section 135 includes a rotary encoder 139. The rotary encoder 139 detects the rotation angle of the first motor 92. In one example, the rotary encoder 139 detects the rotation angle of camshaft 122. Specifically, the rotary encoder 139 detects the amount of rotation of the camshaft 122.

The rotary encoder 139 includes an encoder 140 and a scale 141. The encoder 140 is mounted to the valve base 108. The encoder 140 reads scale 141. The scale 141 is mounted to the camshaft 122. The scale 141 rotates together with camshaft 122. At this time, the scale 141 is read by the encoder 140. As a result, the rotary encoder 139 detects the rotation amount of the camshaft 122.

The detection section 135 detects the rotation amount of the camshaft 122 from the reference angle. As a result, the detection section 135 detects the rotation angle of the camshaft 122. When the first motor 92 rotates in the reverse direction, accurately controls the rotation angle of the first motor 92 by the detection section 135. In one example, when the camshaft 122 is at the reference angle, the pump cam 118 closes the pump valve 109, the release cam 119 opens the release valve 110, the pressurizing cam 120 opens the pressurizing valve 111, and the choke cam 121 opens the choke valve 112. When camshaft 122 rotates from the reference angle, the phase of the plurality of cams change.

The detection section 135 may be configured of only the photosensor unit 136. In this case, it is desirable that a plurality of slits corresponding to the rotation angle of the camshaft 122 are formed in the shield plate 138. As a result, the photo interrupter 137 can detect the rotation angle corresponding to the slit.

The first pump unit 82 is controlled by the control section 42. Specifically, the first motor 92 is controlled by the control section 42. When rotated in the reverse direction, the first motor 92 is PID controlled based on the detection result by the detection section 135 by the control section 42. As a result, the phase of the cam is accurately controlled. When rotated in the forward direction, the first motor 92 is open controlled by the control section 42. When the first motor 92 rotates in the forward direction, the camshaft 122 does not rotate. Therefore, the detection section 135 cannot detect the rotation angle. When the first motor 92 rotates in the forward direction, only the first pump 93 is driven. Therefore, when the first motor 92 rotates in the forward direction, it is not necessary to finely control the rotation angle of the first motor 92.

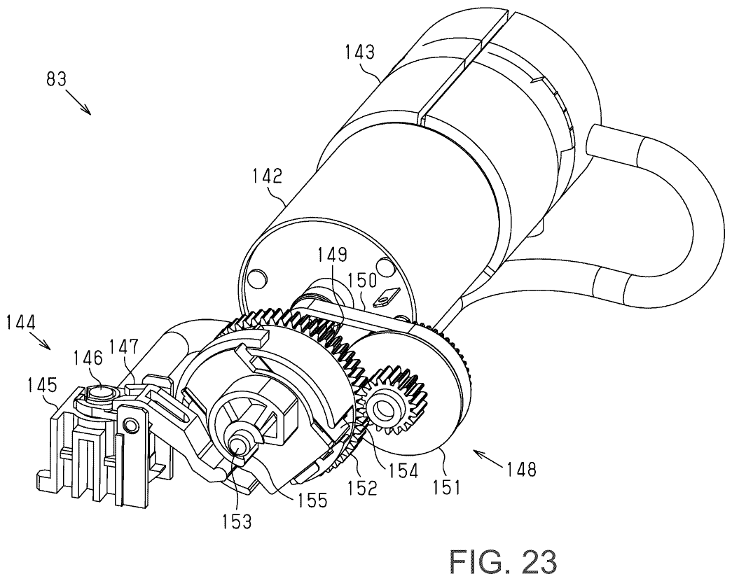

As shown in FIG. 23, the second pump unit 83 includes a motor. Specifically, the second pump unit 83 includes a second motor 142. The second motor 142 is configured to rotate in the forward direction and the reverse direction. In one example, similarly to the first motor 92, the second motor 142 is configured to be capable of extracting power from both shafts.

The second pump unit 83 includes a pump. Specifically, the second pump unit 83 includes a second pump 143. The second pump 143 changes the pressure of the accommodation section 28. In one example, the second pump 143 is a decompression pump. The second pump 143 may be a pressurization pump.

The second pump 143 is connected to the second motor 142. The second pump 143 is driven by the power of the second motor 142. By the second motor 142 is driven, the second pump 143 is driven. In one example, both when the second motor 142 is in a forward rotation and when the second motor 142 is in a reverse rotation, the second pump 143 is driven so as to generate a negative pressure.

The second pump 143 is configured to change the pressure of at least one of the plurality of connect destinations of the pressure changing unit 81. The second pump 143 is connected to at least one connect destination of the plurality of connect destinations of the pressure changing unit 81. In other words, the second pump 143 is connected to at least one of the plurality of plurality of connect destinations of the first pump 93. In one example, the second pump 143 is connected to all of the plurality of connect destinations of the first pump 93. The second pump 143 is connected to the plurality of accommodation sections 28. The second pump 143 is connected to the opening and closing valve 52, the pressurizing section 53, and the flow path pump 71. Therefore, by the first pump 93 and the second pump 143 cooperation, the pressure changing unit 81 can change the pressure of the accommodation section 28.

The second pump unit 83 includes an air release section 144. The air release section 144 is connected to the plurality of connect destinations of the pressure changing unit 81. The air release section 144 is configured to open the plurality of connect destinations to the atmosphere. That is, the air release section 144 causes the accommodation section 28 to open to the atmosphere. Specifically, the air release section 144 causes the air chamber C2 to open to the atmosphere. In one example, the air release section 144 causes the choke air chamber C6, the pressurizing air chamber C8, the pump air chamber C13, and the like to open to the atmosphere.

The air release section 144 includes an air release base 145, an air release valve 146, and an air release lever 147. The air release base 145 is configured to communicate with the atmosphere within the air release base 145. The air release valve 146 is mounted to the air release base 145. The air release valve 146 opens and closes the air release base 145. When the air release valve 146 is opened, the air release base 145 is opened to the atmosphere. The air release lever 147 is mounted to the air release base 145. The air release lever 147 is connected to the air release valve 146. The air release lever 147 lifts the air release valve 146. As a result, the air release valve 146 is opened.

The air release section 144 is configured to, when the second motor 142 rotates in the forward direction, close. The air release section 144 is configured to, when the second motor 142 rotates in the reverse direction, open. Specifically, by transmitting the power from the second motor 142, when the second motor 142 rotates in the forward rotation, the air release section 144 is closed and when the second motor 142 rotates in the reverse rotation, the air release section 144 is opened.

The second pump unit 83 includes a transmission section. Specifically, the second pump unit 83 includes a second transmission section 148. The second transmission section 148 is positioned between the second motor 142 and the air release section 144. Specifically, the second transmission section 148 is positioned between the second motor 142 and the air release section 144 in the path through which the power of the second motor 142 is transmitted.

The second transmission section 148 is configured to transmit the power of the second motor 142 to the air release section 144. Specifically, the second transmission section 148 transmits the power of the second motor 142 to the air release lever 147. The second transmission section 148 causes the air release lever 147 to operate by the power of the second motor 142. As a result, the air release valve 146 is opened and closed.

The second transmission section 148 is configured to cause the rotation direction of the second motor 142 to correspond to the opening and closing of the air release valve 146. When the second motor 142 rotates in the forward direction, the second transmission section 148 causes the air release valve 146 to close. When the second motor 142 rotates in the reverse direction, the second transmission section 148 causes the air release valve 146 to open. In this manner, in the second pump unit 83, it is possible to drive the second pump 143 and to drive the air release section 144 by the second motor 142.

The second transmission section 148 includes a drive pinion 149. The drive pinion 149 is mounted to the second motor 142. Specifically, the drive pinion 149 is mounted to the shaft of the second motor 142.

The second transmission section 148 includes a drive belt 150. The drive belt 150 is wound around the drive pinion 149. The drive belt 150 rotates together with the drive pinion 149. The drive belt 150 transmits the power of the drive pinion 149.

The second transmission section 148 includes a plurality of gears. In one example, the second transmission section 148 includes a drive gear 151 and a connection gear 152.

The drive gear 151 is connected to the drive pinion 149. Specifically, the drive belt 150 is wrapped around the drive gear 151. Via a drive belt 150, the drive gear 151 is connected to the drive pinion 149. The drive gear 151 rotates together with the drive pinion 149. The drive gear 151 may be positioned to directly mesh with the drive pinion 149.

The connection gear 152 is connected to the drive gear 151. The connection gear 152 rotates together with the drive gear 151. The connection gear 152 is supported by a connection shaft 153 (to be described later).

The second transmission section 148 includes the connection shaft 153. The connection shaft 153 rotates together with the connection gear 152.

The second transmission section 148 includes a friction clutch 154. The friction clutch 154 is supported by the connection shaft 153. The friction clutch 154 is configured to, when a predetermined torque or more is applied, slip with respect to the connection shaft 153.

The second transmission section 148 includes an air release cam 155. The air release cam 155 is mounted to the friction clutch 154. The air release cam 155 rotates together with the friction clutch 154.

The air release cam 155 contacts the air release lever 147. The air release cam 155 pushes down the air release lever 147. As a result, the air release valve 146 is opened.

When the second motor 142 rotates in the forward direction, the air release cam 155 causes the air release lever 147 to operate such that the air release section 144 closes. That is, when the second motor 142 rotates in the forward direction, the air release cam 155 does not push down the air release lever 147. When the air release cam 155 does not push down the air release lever 147, the air release valve 146 closes the air release base 145 by the action of its own weight, a spring, or the like. When the second motor 142 rotates in the reverse direction, the air release cam 155 causes the air release lever 147 to operate such that the air release section 144 opens. That is, when the second motor 142 rotates in the reverse direction, the air release cam 155 pushes down the air release lever 147.

The phase of the air release cam 155 is limited to a predetermined range by the friction clutch 154. Therefore, when the second motor 142 rotates in the forward direction, the phase of the air release cam 155 is maintained in a state in which the air release lever 147 is not pushed down. When the second motor 142 rotates in the reverse direction, the phase of the air release cam 155 maintains a state in which the air release lever 147 is pushed down. For example, by the air release cam 155 contacting a regulating member (not shown), the phase of the air release cam 155 is limited. At this time, the friction clutch 154 slides relative to the connection shaft 153.

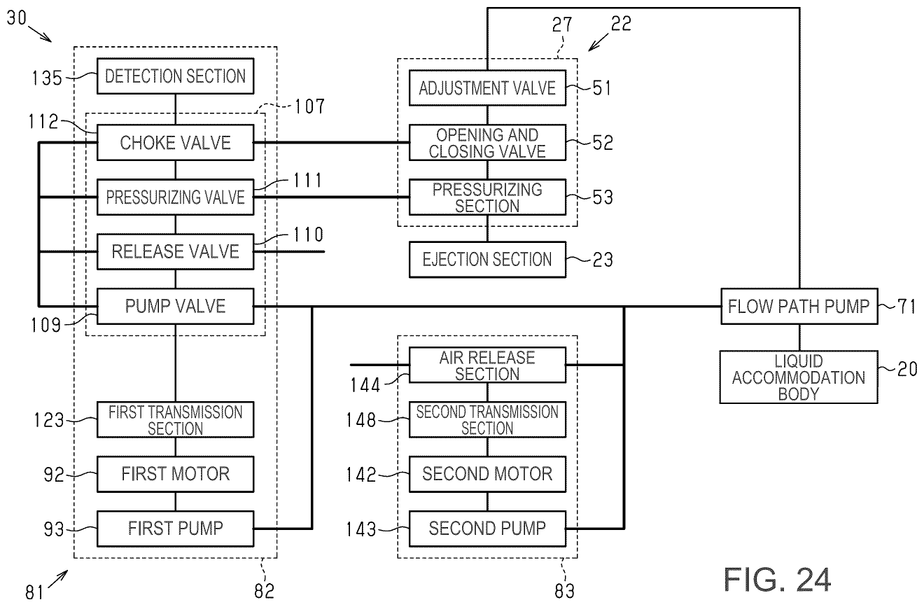

As shown in FIG. 24, the first pump unit 82 and the second pump unit 83 are connected to each other. The second pump unit 83 is connected between the first pump unit 82 and the flow path pump 71. Specifically, the second pump 143 is connected between the first pump 93 and the flow path pump 71. That is, the second pump 143 is connected to the flow path pump pipe 103. The second pump 143 is connected to the pump air pipe 75. The first pump 93 and the second pump 143 always communicate with the flow path pump 71. By the selector valve 107 opening, the first pump 93 and the second pump 143 communicate with the flow section 27. A specific operation of the pressure changing unit 81 will be described later.

As shown in FIG. 4, FIG. 5, FIG. 6, and FIG. 7, the liquid supply unit 30 includes the supply flow path 161. The supply flow path 161 is a flow path through which the liquid flows. Specifically, the supply flow path 161 is a flow path through which the liquid flows toward the liquid ejection unit 22. The liquid is supplied to the ejection section 23 through the supply flow path 161. The supply flow path 161 is connected to the liquid accommodation body 20 and the liquid ejection unit 22. Specifically, the supply flow path 161 is connected to the liquid accommodation body 20 and the flow section 27. In one example, the supply flow path 161 is connected to the mount section 18 and the ejection joint 54. The supply flow path 161 is connected to the accommodation section 28 such as the opening and closing valve 52 and the pressurizing section 53 through the ejection joint 54. The supply flow path 161 communicates with the liquid chamber C1.

The liquid supply unit 30 includes the air flow path 162. The air flow path 162 is a flow path through which air flows. The air flow path 162 is connected to the pressure changing unit 81. Specifically, the air flow path 162 is connected to the pump unit. More specifically, the air flow path 162 is connected to a pump. In one example, the air flow path 162 is connected to the first pump 93 and the second pump 143.

The air flow path 162 is connected to the plurality of connect destinations of the pressure changing unit 81. The pressure changing unit 81 is connected to the plurality of connect destinations by the air flow path 162. The air flow path 162 is connected to the accommodation section 28. In one example, the air flow path 162 is connected to the plurality of accommodation section 28. The air flow path 162 is connected to the opening and closing valve 52, the pressurizing section 53, and the flow path pump 71. The decompression by the pump unit acts on the opening and closing valve 52, the pressurizing section 53, and the flow path pump 71 through the air flow path 162. The air flow path 162 communicates with the air chamber C2.

The supply flow path 161 and the air flow path 162 each have a fixed portion and a movable portion. The supply flow path 161 includes a first fixed portion 163 and a first moving portion 164. The air flow path 162 includes a second fixed portion 165 and a second moving portion 166. The fixing portion is a portion that fixes to the housing 12. The movable portion is a portion that is deformed as the liquid ejection unit 22 moves in the scanning direction D1.

The first fixed portion 163 is connected to the mount section 18 and a relay joint 168 (to be described later). Since the positional relationship between the mount section 18 and the relay joint 168 does not change, the first fixed portion 163 is not deformed.

The first moving portion 164 is connected to the relay joint 168 and the liquid ejection unit 22. Specifically, the first moving portion 164 is connected to the relay joint 168 and the flow section 27. The first moving portion 164 is connected to the relay joint 168 and the ejection joint 54. By the liquid ejection unit 22 moving, the positional relationship between the relay joint 168 and the ejection joint 54 changes. Therefore, the first moving portion 164 is deformed.

The second fixed portion 165 is connected to the flow path pump 71 and the pump unit. Specifically, the second fixed portion 165 is connected to the flow path pump 71, the first pump unit 82, and the second pump unit 83. The second fixed portion 165 extends from the flow path pump 71 toward the first pump unit 82. The second fixed portion 165 is connected to the second pump unit 83 in the intermediate of extending from the flow path pump 71 toward the first pump unit 82. Since the positional relationship between the flow path pump 71, the first pump unit 82, and the second pump unit 83 does not change, the second fixed portion 165 is not deformed.

The second moving portion 166 is connected to the relay joint 168 and the liquid ejection unit 22. Specifically, the second moving portion 166 is connected to the relay joint 168 and the flow section 27. The second moving portion 166 is connected to the relay joint 168 and the ejection joint 54. Similarly to the first moving portion 164, by the liquid ejection unit 22 moving, the second moving portion 166 is deformed.

The liquid supply unit 30 includes a guide member 167. The guide member 167 is configured to guide the supply flow path 161 and the air flow path 162. The guide member 167 is fixed to the housing 12. The guide member 167 guides the fixed portion. The guide member 167 guides the first fixed portion 163 from the flow path pump 71 to the relay joint 168. The guide member 167 guides the second fixed portion 165 from the flow path pump 71 to the first pump unit 82. The guide member 167 guides the second fixed portion 165 from the second pump unit 83 to the first pump unit 82.

The liquid supply unit 30 includes the relay joint 168. The relay joint 168 is configured so as to relay the supply flow path 161 and the air flow path 162. The relay joint 168 is positioned in the intermediate of the supply flow path 161. The relay joint 168 is positioned in the intermediate of the air flow path 162. The relay joint 168 is, for example, mounted to the frame 32.

The relay joint 168 is connected to the first pump unit 82. Specifically, the relay joint 168 is connected to the pressurizing tube 105 and the choke tube 106. The relay joint 168 is connected to the pressurizing tube 105 and the choke tube 106 through, for example, a tube.

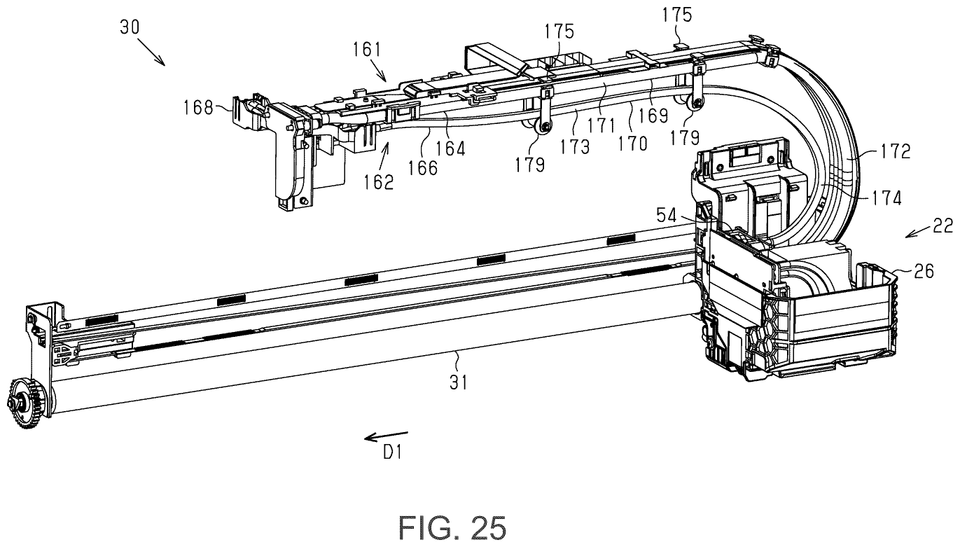

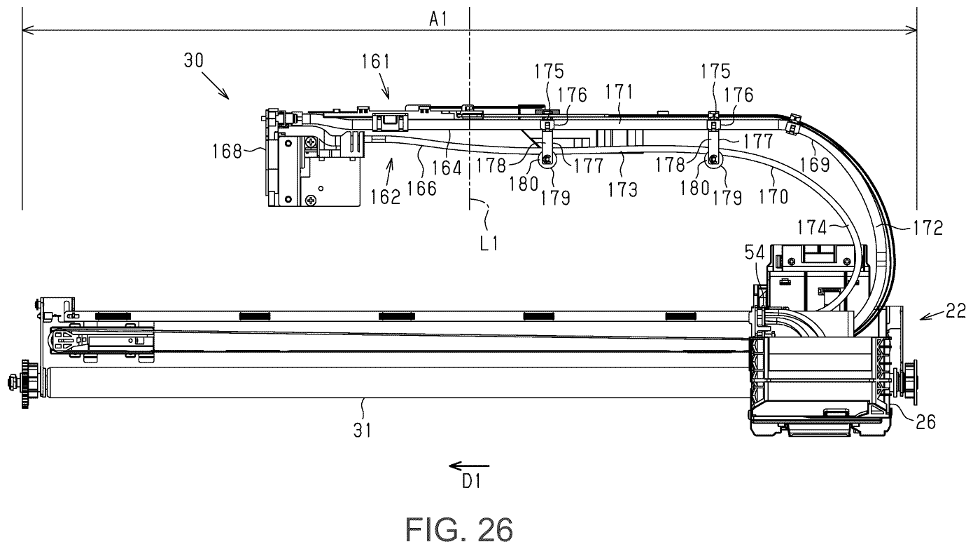

As shown in FIG. 25 and FIG. 26, the liquid supply unit 30 includes a plurality of flexible members. Specifically, the supply flow path 161 and the air flow path 162 each include the flexible member. Specifically, the supply flow path 161 includes a first flexible member 169. The air flow path 162 includes a second flexible member 170. The flexible member is a member having flexibility. The flexible member is a tube. The first flexible member 169 is a liquid tube. In one example, the first flexible member 169 is a multiple tube. The second flexible member 170 is an air tube.

The flexible member constitutes the moving portion. The first flexible member 169 constitutes the first moving portion 164. The second flexible member 170 constitutes the second moving portion 166. Therefore, the first flexible member 169 and the second flexible member 170 are deformed as the liquid ejection unit 22 is moved. The fixed portion may be configured of a flexible member like the movable portion or may be configured of a rigid member having rigidity. The rigid member is, for example, a pipe. In one example, the first fixed portion 163 and the second fixed portion 165 may each be configured of the flexible member.

The first flexible member 169 and the second flexible member 170 extend to be aligned. The first flexible member 169 and the second flexible member 170 extend from the relay joint 168 toward the liquid ejection unit 22. The first flexible member 169 and the second flexible member 170 extend while bending. By the first flexible member 169 and the second flexible member 170 aligning, an increase in the arrangement space of the first flexible member 169 and the second flexible member 170 is suppressed.

The first flexible member 169 and the second flexible member 170 each include an extended portion and a bending portion. The first flexible member 169 includes a first extended portion 171 and a first bending portion 172. The second flexible member 170 includes a second extended portion 173 and a second bending portion 174. The extended portion is a portion that extends in the scanning direction D1. Specifically, the extended portion is a portion that extends linearly from the relay joint 168. The bending portion is a portion that bends in an arc shape from the extended portion toward the liquid ejection unit 22. By the liquid ejection unit 22 moving, the lengths of the extended portion and the bending portion change. In one example, as the liquid ejection unit 22 moves toward the scanning direction D1, the extended portion becomes shorter and the bending portion becomes longer.

The elasticity of the first flexible member 169 is greater than the elasticity of the second flexible member 170. This is because the first flexible member 169 is required to have a higher barrier property than the second flexible member 170. In the first flexible member 169, a thick-walled tube is employed to prevent air from entering the liquid. Therefore, the first flexible member 169 may be less likely to be deformed than the second flexible member 170 in some cases.

The first flexible member 169 extends while being aligned so as to have a curvature smaller than that of the second flexible member 170. That is, the first flexible member 169 is bent so as to pass through the outside of the second flexible member 170. As a result, the curvature of the first flexible member 169 is smaller than the curvature of the second flexible member 170. By the curvature of the first flexible member 169 reducing, the reaction force acting on the liquid ejection unit 22 is reduced.

As shown in FIG. 26, the upstream end of the first flexible member 169 and the upstream end of the second flexible member 170 are positioned on one side with respect to the center of the movement region A1. Specifically, the upstream end of the first flexible member 169 and the upstream end of the second flexible member 170 are positioned on one side of a centerline L1 in the scanning direction D1. The centerline L1 is a virtual line that divides the movement region A1 into two in the scanning direction D1. That is, the upstream end of the first flexible member 169 and the upstream end of the second flexible member 170 are positioned collectively in the scanning direction D1. This is because the relay joint 168 is positioned on one side of the centerline L1. Since the upstream end of the first flexible member 169 and the upstream end of the second flexible member 170 are positioned collectively, the first flexible member 169 and the second flexible member 170 are easily detached.

By the upstream end of the first flexible member 169 and the upstream end of the second flexible member 170 positioning collectively, a concern that the length of the first flexible member 169 and the length of the second flexible member 170 greatly deviate from each other is reduced. By the length of the first flexible member 169 and the length of the second flexible member 170 are close to each other, the first flexible member 169 and the second flexible member 170 can be easily aligned with each other. As a result, the space occupied by the first flexible member 169 and the second flexible member 170 can be reduced.

Since the first flexible member 169 and the second flexible member 170 are deformed as the liquid ejection unit 22 moves, the first flexible member 169 and the second flexible member 170 may rub against other members. In this case, the first flexible member 169 and the second flexible member 170 may be worn out.

As shown in FIG. 25 and FIG. 26, the liquid supply unit 30 includes one or more bundling members 175. In one example, the liquid supply unit 30 includes two bundling members 175. The bundling member 175 is a member that bundles the supply flow path 161 and the air flow path 162. The bundling member 175 bundles the first moving portion 164 and the second moving portion 166. The bundling member 175 bundles the first flexible member 169 and the second flexible member 170. The bundling member 175 bundles the first flexible member 169 and the second flexible member 170 so as not to contact each other. As a result, a concern that the first flexible member 169 and the second flexible member 170 rub against each other is reduced.

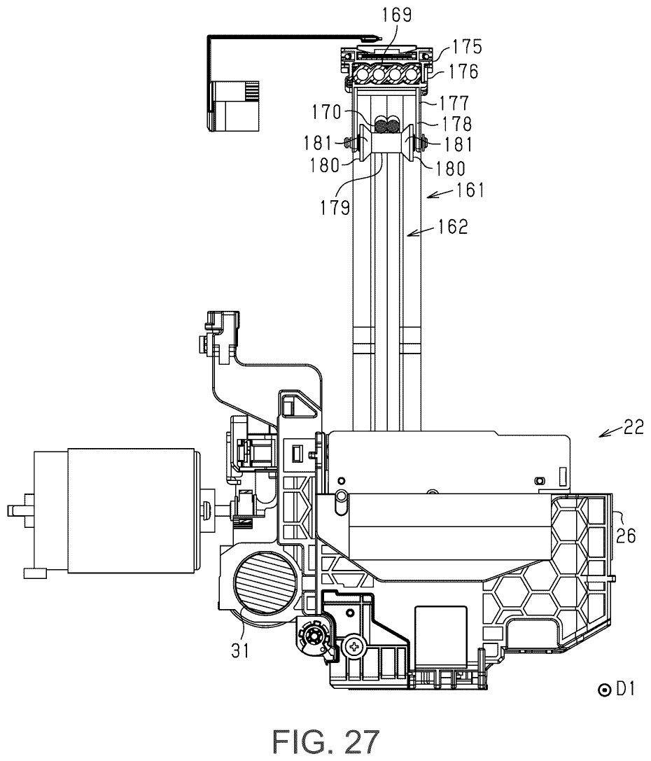

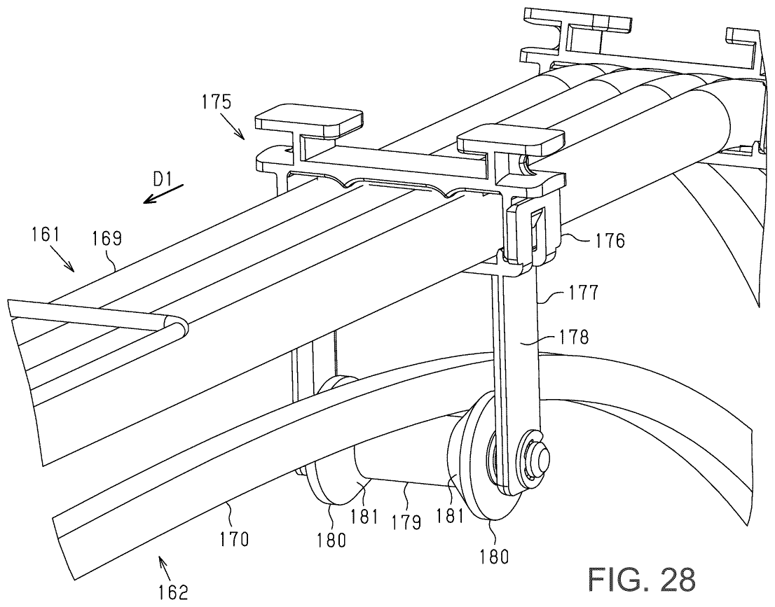

As shown in FIG. 27 and FIG. 28, the bundling member 175 includes a holding section 176. The holding section 176 holds the first flexible member 169. By sandwiching the first flexible member 169, the holding section 176 holds the first flexible member 169. Therefore, even if the first flexible member 169 is deformed, the holding section 176 and the first flexible member 169 do not rub against each other. Therefore, a concern that wearing out the first flexible member 169 is reduced. The holding section 176 is, for example, a clamp.

The bundling member 175 includes a support section 177. The support section 177 extends from the holding section 176. The support section 177 extends from the holding section 176 so as to approach the liquid ejection unit 22. The support section 177 shown in FIG. 27 and FIG. 28 extends downward.

The support section 177 supports the second flexible member 170. The support section 177 supports the second flexible member 170 such that the first flexible member 169 and the second flexible member 170 are spaced apart from each other. The support section 177 supports the second flexible member 170 so as to be along with the first flexible member 169. The support section 177 supports, for example, the second flexible member 170 so as to be suspended from the first flexible member 169.

The support section 177 includes arms 178. The arms 178 extend from the holding section 176. The arms 178 extend from the holding section 176 so as to approach the liquid ejection unit 22.

The support section 177 includes a pulley 179. The pulley 179 is mounted to the arms 178. The pulley 179 is rotatable relative to the arms 178. The pulley 179 contacts the second flexible member 170. The pulley 179 supports the second flexible member 170.

The pulley 179 includes flanges 180 at both axial ends thereof. The pulley 179 is configured such that the diameters at both ends in the axial direction so as to be larger than the diameter at the center by the flanges 180. As a result, a concern that the second flexible member 170 falling off from the pulley 179 is reduced. A concern that the second flexible member 170 is in contact with the arms 178 is reduced. As a result, a concern that wearing out the second flexible member 170 is reduced.

The flange 180 may include a slope surface 181. The slope surface 181 is inclined such that the diameter of the flange 180 decreases toward the center in the axial direction. As a result, the second flexible member 170 is likely to be concentrated at the center of the pulley 179.

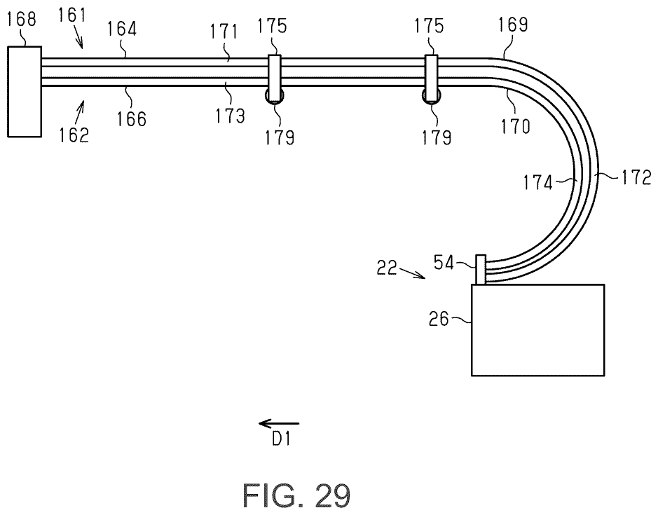

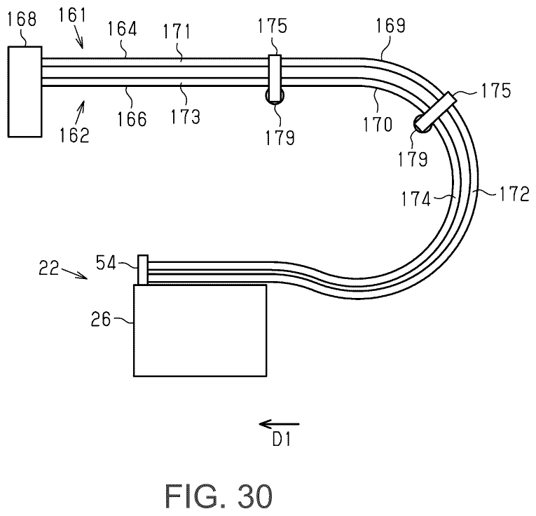

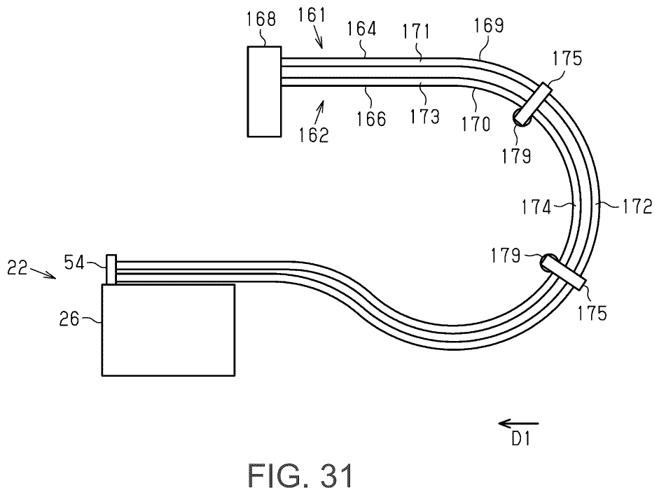

As shown in FIG. 29, FIG. 30, and FIG. 31, the bundling member 175 may hold the first extended portion 171 or the first bending portion 172 with respect to the first flexible member 169. The bundling member 175 holds the first extended portion 171 or the first bending portion 172 according to the position of the liquid ejection unit 22. In one example, when the liquid ejection unit 22 at the standby position, the two bundling members 175 hold the first extended portion 171. When the liquid ejection unit 22 is positioned at the turning position, the two bundling members 175 hold the first bending portion 172. When the liquid ejection unit 22 is positioned between the standby position and the turning position, among the two bundling members 175, one holds the first extended portion 171 and the other holds the first bending portion 172.

The bundling member 175 may support the second extended portion 173 or the second bending portion 174 with respect to the second flexible member 170. The bundling member 175 supports the second extended portion 173 or the second bending portion 174 according to the position of the liquid ejection unit 22. In one example, when the liquid ejection unit 22 at the standby position, the two bundling members 175 support the second extended portion 173. When the liquid ejection unit 22 is positioned at the turning position, the two bundling members 175 hold the second bending portion 174. When the liquid ejection unit 22 is positioned between the standby position and the turning position, among the two bundling members 175, one holds the second extended portion 173 and the other holds the second bending portion 174.

In the bundling member 175 in which the holding section 176 holds the first extended portion 171, the support section 177 supports the second flexible member 170 at a position closer to the liquid ejection unit 22 than the holding section 176. This is because the support section 177 extends from the holding section 176 so as to approach the liquid ejection unit 22. For example, the support section 177 supports the second flexible member 170 below the holding section 176. In one example, when the liquid ejection unit 22 is positioned at the standby position, the two bundling members 175 are positioned such that the holding section 176 holds the first extended portion 171 and the support section 177 supports the second flexible member 170 below the holding section 176. When the liquid ejection unit 22 is positioned between the standby position and the turning position, one bundling member 175 is positioned such that the holding section 176 holds the first extended portion 171 and the support section 177 supports the second flexible member 170 below the holding section 176.

When the second flexible member 170 is deformed in association with the movement of the liquid ejection unit 22, the positional relationship between the pulley 179 and the second flexible member 170 changes. At this time, the pulley 179 is rotated by friction with the second flexible member 170. Therefore, a concern that the pulley 179 rubs against the second flexible member 170 is reduced. Therefore, a concern that wearing out the second flexible member 170 is reduced.

### Operation of Pressure Changing Unit

Next, the operation of the pressure changing unit 81 will be described. The pressure changing unit 81 is controlled by control section 42.

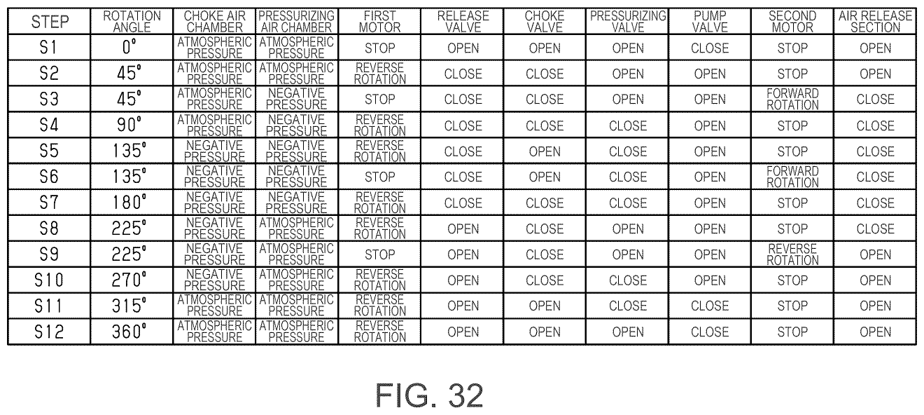

As shown in FIG. 32, when executing the pressurized cleaning, the control section 42 operates the pressure changing unit 81 from step S1 to step S12. From step S1 to step S12 indicate the states of the pressure changing unit 81. The control section 42 rotates the camshaft 122 one rotation from step S1 to step S12. In one example, the state of the selector valve 107 changes each time the camshaft 122 rotates 45°.

Step S1 shows a standby state of the pressure changing unit 81. When the pressure cleaning is not executed, the pressure changing unit 81 stands by in the state of step S1. In step S1, the rotation angle of camshaft 122 is 0°. In step S1, camshaft 122 stands by at the reference angle. In step S1, the first motor 92 and the second motor 142 are stopped. In step S1, the release valve 110, the choke valve 112, and the pressurizing valve 111 are opened. Therefore, in step S1, the choke air chamber C6 and the pressurizing air chamber C8 are opened to the atmosphere. In step S1, the pump valve 109 is closed. Therefore, in step S1, the first pump 93 and the second pump 143 are cut off with the flow section 27. In step S1, the air release section 144 is opened.

When the pressurizing cleaning is started, the control section 42 rotates the first motor 92 in the reverse direction. At this time, control section 42 rotates camshaft 122 by 45°. As a result, the state of the pressure changing unit 81 shifts from step S1 to step S2.

In step S2, the rotation angle of camshaft 122 is 45°. In step S2, the release valve 110 and the choke valve 112 are closed. In step S2, the pressurizing valve 111 and the pump valve 109 are opened. Therefore, in step S2, the pressurizing section 53 communicates with the first pump 93 and the second pump 143.

Next, the control section 42 stops the first motor 92. The control section 42 rotates the second motor 142 in the forward direction. As a result, the state of the pressure changing unit 81 shifts from step S2 to step S3.

In step S3, by the second motor 142 rotating in the forward direction, the air release section 144 is closed. In step S3, the pressurizing air chamber C8 becomes negative pressure by the second pump 143. As a result, the liquid flows into the pressurizing liquid chamber C7.

Next, the control section 42 rotates the first motor 92 in the reverse direction. At this time, control section 42 rotates camshaft 122 by 45°. The control section 42 stops the second motor 142. As a result, the state of the pressure changing unit 81 shifts from step S3 to step S4.

In step S4, the rotation angle of camshaft 122 is 90°. In step S4, the release valve 110, the choke valve 112, and the pressurizing valve 111 are closed. By the pressurizing valve 111 closing, the pressurizing air chamber C8 is maintained at the negative pressure.

Next, the control section 42 rotates the first motor 92 in the reverse direction. At this time, control section 42 rotates camshaft 122 by 45°. As a result, the state of the pressure changing unit 81 shifts from step S4 to step S5.

In step S5, the rotation angle of camshaft 122 is 135°. In step S5, the release valve 110 and the pressurizing valve 111 are closed. In step S5, the choke valve 112 and the pump valve 109 are opened. Therefore, the first pump 93 and the second pump 143 communicate with the opening and closing valve 52. Therefore, the choke air chamber C6 becomes negative pressure by the first pump 93.

Next, the control section 42 stops the first motor 92. The control section 42 rotates the second motor 142 in the forward direction. As a result, the state of the pressure changing unit 81 shifts from step S5 to step S6.

In step S6, the choke air chamber C6 becomes negative pressure by the second pump 143. By the choke air chamber C6 depressurizing from step S5 to step S6, the opening and closing valve 52 is closed.

Next, the control section 42 rotates the first motor 92 in the reverse direction. At this time, control section 42 rotates camshaft 122 by 45°. The control section 42 stops the second motor 142. As a result, the state of the pressure changing unit 81 shifts from step S6 to step S7.

In step S7, the rotation angle of camshaft 122 is 180°. In step S7, the release valve 110, the choke valve 112, and the pressurizing valve 111 are closed. By the choke valve 112 closing, the choke air chamber C6 is maintained at the negative pressure. Therefore, the opening and closing valve 52 is maintained in a closed state.

Next, the control section 42 rotates the first motor 92 in the reverse direction. At this time, control section 42 rotates camshaft 122 by 45°. As a result, the state of the pressure changing unit 81 shifts from step S7 to step S8.

In step S8, the rotation angle of camshaft 122 is 225°. In step S8, the release valve 110 and the pressurizing valve 111 are opened. Therefore, the pressurizing air chamber C8 is opened to the atmosphere. As a result, the liquid is pushed out from the pressurizing liquid chamber C7 toward the ejection section 23. That is, the liquid is forcibly discharged from the nozzle 25.

Next, the control section 42 stops the first motor 92. The control section 42 rotates the second motor 142 in the reverse direction. As a result, the state of the pressure changing unit 81 shifts from step S8 to step S9.

In step S9, by the second motor 142 rotating in the reverse direction, the air release section 144 is opened. Therefore, in step S9, the pressurizing air chamber C8 is opened to the atmosphere through the release tube 104 and the air release section 144.

Next, the control section 42 rotates the first motor 92 in the reverse direction. At this time, control section 42 rotates camshaft 122 by 45°. The control section 42 stops the second motor 142. As a result, the state of the pressure changing unit 81 shifts from step S9 to step S10.

In step S10, the rotation angle of camshaft 122 is 270°. In step S10, the release valve 110 and the pump valve 109 are opened. In step S10, the choke valve 112 and the pressurizing valve 111 are closed. By the pressurizing valve 111 closing, the first pump 93 and the second pump 143 are cut off with the pressurizing section 53.

Next, the control section 42 rotates the first motor 92 in the reverse direction. At this time, control section 42 rotates camshaft 122 by 45°. As a result, the state of the pressure changing unit 81 shifts from step S10 to step S11.

In step S11, the rotation angle of camshaft 122 is 315°. In step S11, the release valve 110 and the choke valve 112 are opened. In step S11, the pressurizing valve 111 and the pump valve 109 are closed. By the choke valve 112 opening, the choke air chamber C6 is opened to the atmosphere. As a result, the opening and closing valve 52 is opened.

Next, the control section 42 rotates the first motor 92 in the reverse direction. At this time, control section 42 rotates camshaft 122 by 45°. As a result, the state of the pressure changing unit 81 shifts from step S11 to step S12.

In step S12, the rotation angle of camshaft 122 is 360°, that is, 0°. Therefore, in step S12, camshaft 122 makes one rotation. In step S12, the release valve 110, choke valve 112, and pressurizing valve 111 are opened. In step S12, the pump valve 109 is closed.

Finally, the control section 42 stops the first motor 92. As a result, the state of the pressure changing unit 81 shifts from step S12 to step S1. By stopping the first motor 92, the control section 42 ends the pressure cleaning.

When the liquid supply operation is executed, the control section 42 causes the flow path pump 71 to drive. The liquid supply operation is an operation of supplying liquid from the liquid accommodation body 20 to the liquid ejection unit 22. In the liquid supply operation, the control section 42 does not operate the switching section 94. For example, when the liquid supply operation is executed, the control section 42 rotates the first motor 92 in the forward direction or stops the first motor 92. The control section 42 alternately repeats the forward rotation of the first motor 92 and the stop of the first motor 92. The control section 42 rotates the second motor 142 in the forward direction or rotates the second motor 142 in the reverse direction. When causing the first motor 92 to rotate in forward rotation, the control section 42 causes the second motor 142 to rotate in forward rotation. When stopping the first motor 92, the control section 42 causes the second motor 142 to rotate in the reverse rotation. As a result, the pump air chamber C13 is depressurized or opened to the atmospheric pressure.

### Operation and Effect of Embodiment

Next, the operation and effects of the above embodiment will be described.

(1) The first transmission section 123 is configured to, when the first motor 92 rotates in the forward direction, not transmit power from the first motor 92 to the switching section 94 and when the first motor 92 rotates in the reverse direction, transmit power from the first motor 92 to the switching section 94. According to the above described configuration, the driving of the first pump 93 and the driving of the switching section 94 are executed by one first motor 92. As a result, a concern that an increase in the size of the pressure changing unit 81 is reduced.

(2) The switching section 94 includes the plurality of valves positioned between the plurality of connect destinations and the first pump 93. The switching section 94 includes the pump valve 109, the release valve 110, the pressurizing valve 111, and the choke valve 112. The switching section 94 includes the plurality of cams configured to open and close the plurality of valves. The switching section 94 includes the pump cam 118, the release cam 119, the pressurizing cam 120, and the choke cam 121. According to the above described configuration, with a relatively simple configuration, it is possible to switch the connection between the plurality of connect destinations and the first pump 93.

(3) The first transmission section 123 includes a one way clutch 134. According to the above described configuration, with a relatively simple configuration, when the first motor 92 rotates in the forward direction, it is possible not to transmit power from the first motor 92 to the switching section 94 and when the first motor 92 rotates in the reverse direction, it is possible to transmit power from the first motor 92 to the switching section 94.

(4) The pressure changing unit 81 includes the second motor 142, the second pump 143, the air release section 144, and the second transmission section 148. The second pump 143 is driven by the power of the second motor 142. The air release section 144 is connected to the plurality of connect destinations and opens the plurality of connect destinations to the atmosphere. The second transmission section 148 is positioned between the second motor 142 and the air release section 144 and configured to transmit the power of the second motor 142 to the air release section 144. The air release section 144 is configured to be, when the second motor 142 rotates in the forward direction, closed and to be, when the second motor 142 rotates in the reverse direction, opened. According to the above described configuration, the driving of the second pump 143 and the opening and closing of the air release section 144 are executed by one second motor 142. The pressure at the connect destination can be changed by the first pump 93 and the second pump 143 and the pressure at the connect destination can be returned to atmospheric pressure by the air release section 144. In this way, it is possible to change the pressure of the connect destination more freely.

(5) When causing the first motor 92 to rotate in the forward direction, the control section 42 open controls the first motor 92. When causing the first motor 92 to rotate in the reverse direction, the control section 42 PID controls the first motor 92 based on the detection result by the detection section 135. According to the above described configuration, by the first motor 92 being PID controlled, it is possible to switch the connection between the multiple connect destinations and the first pump 93 with high accuracy.

(6) At least either the liquid supply unit 30 or the liquid ejection unit 22 includes the accommodation section 28 configured to accommodate the liquid. The accommodation section 28 includes the membrane member 29 configured to divide the inside of the accommodation section 28 into the air chamber C2 and the liquid chamber C1. The plurality of connect destinations include the accommodation section 28. The pressure changing unit 81 changes the pressure in the air chamber C2. According to the above described configuration, by the pressure changing unit 81 changing the pressure of the air chamber C2, the pressure of the liquid chamber C1 is changed. For example, when the liquid chamber C1 is pressurized, the liquid is discharged from the liquid chamber C1. When the liquid chamber C1 is depressurized, the liquid flows into the liquid chamber C1. In this way, by changing the pressures in the air chamber C2, the pressure changing unit 81 can control the flow of the liquid.

(7) Each of the plurality of accommodation sections 28 is provided in the liquid supply unit 30 or the liquid ejection unit 22. The pressure changing unit 81 selectively changes the pressures in the air chamber C2. According to the above described configuration, the pressure changing unit 81 can finely control the flow of the liquid.

(8) The fixing member 41 is configured to be attached to and detached from with respect to the pressure changing unit 81 and the frame 32 from above. According to the above described configuration, by accessing the fixing member 41 from above, it is easy to attach and detach the pressure changing unit 81 to and from with respect to the frame 32.

(9) The upstream end of the first flexible member 169 and the upstream end of the second flexible member 170 are positioned on one side with respect to the center of the movement region A1 of the liquid ejection unit 22. According to the above described configuration, the upstream end of the first flexible member 169 and the upstream end of the second flexible member 170 are disposed of collectively. The first flexible member 169 and the second flexible member 170 extend toward the flow section 27. Therefore, a possibility that the length of the first flexible member 169 and the length of the second flexible member 170 greatly deviate from each other is reduced. By the length of the first flexible member 169 and the length of the second flexible member 170 are close to each other, the first flexible member 169 and the second flexible member 170 can be easily aligned with each other. As a result, the space occupied by the first flexible member 169 and the second flexible member 170 can be reduced.

(10) The bundling member 175 includes the holding section 176 configured to hold the first flexible member 169 and the support section 177 configured to support the second flexible member 170. The support section 177 includes the pulley 179 configured to contact with the second flexible member 170. According to the above described configuration, a concern that the second flexible member 170 is damaged by friction with the first flexible member 169 and the bundling member 175 is reduced.

(11) The pulley 179 includes flanges 180 at both axial ends. According to the above described configuration, a concern that the second flexible member 170 is in contact with a portion other than the pulley 179 is reduced by the flanges 180.

(12) The first flexible member 169 is the liquid tube configured to supply the liquid to the liquid ejection unit 22. According to the above described configuration, the bundling member 175 can hold the liquid tube.

(13) The second flexible member 170 is the air tube configure to supply air to the liquid ejection unit 22. According to the above described configuration, a concern of wearing out the air tube is reduced.

(14) The liquid tube includes the first extended portion 171 extending in the scanning direction D1 and the first bending portion 172 bent in an arc shape from the first extended portion 171 toward the liquid ejection unit 22. The holding section 176 holds the first extended portion 171. The support section 177 supports the air tube at a position closer to the liquid ejection unit 22 than the holding section 176. According to the above described configuration, by the support section 177 supporting the air tube at a position closer to the liquid ejection unit 22 than the holding section 176, the curvature of the air tube is larger than the curvature of the liquid tube. The material for the air tube can be selected more for its good bending property than for its barrier property, compared with the liquid tube. Therefore, even if the curvature of the air tube becomes larger than that of the liquid tube, there is no problem. By the support section 177 supporting the air tube at a position closer to the liquid ejection unit 22 than the holding section 176, the space occupied by the space occupied by the air tube and the liquid tube can be reduced.

### 2. Second Embodiment

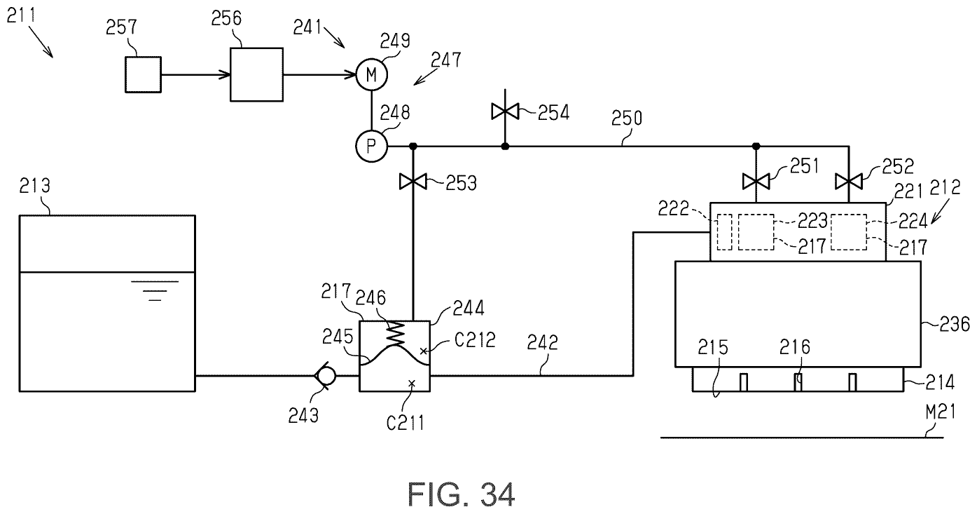

As shown in FIG. 34, a liquid ejection device 211 includes a liquid ejection unit 212. The liquid ejection unit 212 is configured to eject a liquid. By ejecting the liquid onto a medium M21, the liquid ejection unit 212 prints an image on the medium M21.

The liquid is supplied from a liquid accommodation body 213 to the liquid ejection unit 212. The liquid accommodation body 213 accommodates the liquid. The liquid accommodation body 213 is, for example, an ink cartridge or an ink tank. The liquid accommodation body 213 is mounted on the liquid ejection device 211. The liquid ejection device 211 is configured so that the liquid accommodation body 213 can be mounted.

The liquid ejection unit 212 includes an ejection section 214. The ejection section 214 includes a nozzle surface 215. The nozzle surface 215 is a surface facing the medium M21. One or more nozzles 216 are opened in the nozzle surface 215. The ejection section 214 ejects the liquid from the nozzles 216.

The liquid ejection device 211 includes one or more accommodation sections 217 connected to the ejection section 214. In one example, the liquid ejection device 211 includes a plurality of accommodation sections 217. The accommodation section 217 is configured to accommodate the liquid. The accommodation section 217 is positioned between the liquid accommodation body 213 and the ejection section 214. The accommodation section 217 accommodates the liquid between the liquid accommodation body 213 and the ejection section 214. The accommodation section 217 is, for example, an opening and closing valve 223, a pressurizing section 224, and a flow path pump 244. The opening and closing valve 223, the pressurizing section 224, and the flow path pump 244 will be described later.

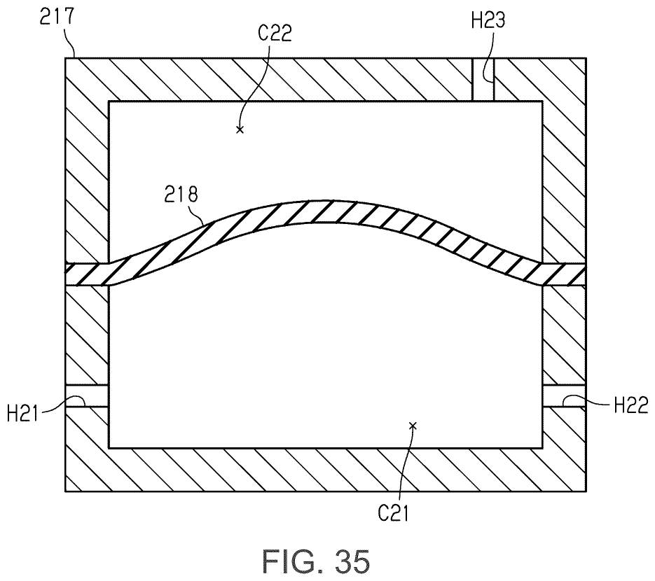

Based on FIG. 35, a common configuration of the accommodation section 217 will be described. As shown in FIG. 35, the accommodation section 217 includes a membrane member 218. The membrane member 218 is a flexible member. The membrane member 218 is deformable. The membrane member 218 divides the inside of the accommodation section 217 into a liquid chamber C21 and an air chamber C22. The liquid chamber C21 is a space in which the liquid is accommodated. The air chamber C22 is a space in which air is accommodated. The membrane member 218 partitions the liquid chamber C21 and the air chamber C22. The membrane member 218 constitutes a wall surface of the liquid chamber C21 and a wall surface of the air chamber C22. The membrane member 218 deforms according to the pressure of the liquid chamber C21 and the pressure of the air chamber C22. When the membrane member 218 is deformed, the volume of the liquid chamber C21 and the volume of the air chamber C22 change.

A plurality of openings are formed in the accommodation section 217. Through the plurality of openings, the liquid and the air are supplied to the accommodation section 217 and the liquid and the air are discharged from the accommodation section 217. In one example, an inflow port H21, a pump outflow port H22, and an air port H23 open in the accommodation section 217. The inflow port H21 communicates with the liquid chamber C21. The liquid flows into the liquid chamber C21 through the inflow port H21. The pump outflow port H22 communicates with the liquid chamber C21. The liquid flows out from the liquid chamber C21 through the pump outflow port H22. The air port H23 communicates with the air chamber C22. Through the air port H23, air is supplied to the air chamber C22 and air is discharged from the air chamber C22. That is, through the air port H23, the air chamber C22 is pressurized or the air chamber C22 is depressurized. When the air chamber C22 is pressurized, the membrane member 218 deforms so as to reduce the volume of the liquid chamber C21. As a result, the liquid flows out from the liquid chamber C21 through the pump outflow port H22. When the air chamber C22 is depressurized, the membrane member 218 deforms so as to increase the volume of the liquid chamber C21. As a result, the liquid flows into the liquid chamber C21 through the inflow port H21.

As shown in FIG. 34, the liquid ejection unit 212 includes a flow section 221. In the flow section 221, the liquid supplied to the ejection section 214 flows. The flow section 221 is connected to the ejection section 214. The flow section 221 is positioned between the liquid accommodation body 213 and the ejection section 214.

The flow section 221 may include an adjustment valve 222. The adjustment valve 222 is configured to open and close. The adjustment valve 222 is normally closed. By the adjustment valve 222 opening, the liquid flows into the flow section 221.

The adjustment valve 222 is configured to adjust the pressure in the ejection section 214. In one example, the adjustment valve 222 is configured to adjust the pressure in the flow section 221. By opening and closing based on the pressure in the flow section 221, the adjustment valve 222 adjusts the pressure in the flow section 221. By the pressure in the flow section 221 adjusting, the adjustment valve 222 adjusts the pressure in the ejection section 214.

The adjustment valve 222 is configured to be opened and closed by a differential pressure between the pressure in the ejection section 214 and the atmospheric pressure. In one example, the adjustment valve 222 is opened and closed by a differential pressure between the pressure in the flow section 221 and the atmospheric pressure. Specifically, when the pressure downstream of the adjustment valve 222 is equal to or lower than a predetermined pressure, the adjustment valve 222 opens. That is, when the pressure in the flow section 221 is equal to or less than a predetermined pressure, the adjustment valve 222 opens. When the pressure in the flow section 221 is higher than the predetermined pressure, the adjustment valve 222 closes.

By opening and closing, the adjustment valve 222 maintains the inside of the flow section 221 at the predetermined pressure. By maintaining the inside of the flow section 221 at the predetermined pressure, the adjustment valve 222 maintains the inside of the ejection section 214 at the predetermined pressure. An operating pressure at which the adjustment valve 222 opens is a predetermined negative pressure. Therefore, the inside of the ejection section 214 is maintained at the predetermined negative pressure by the adjustment valve 222. By the inside of the ejection section 214 maintaining at the predetermined negative pressure, a meniscus is formed in the nozzle 216. By the meniscus forming in the nozzle 216, the ejection section 214 can eject the liquid well.

The operating pressure of the adjustment valve 222 is larger than a meniscus pressure resistance. Therefore, the inside of the ejection section 214 is maintained at the negative pressure at which the meniscus is maintained by the adjustment valve 222. When the negative pressure in the ejection section 214 exceeds the meniscus pressure resistance, that is, when the pressure in the ejection section 214 falls below the meniscus pressure resistance, the meniscus may be broken. When the meniscus is broken, there is a concern that air may flow into the ejection section 214 through the nozzle 216.

The flow section 221 includes one or more accommodation sections 217. The flow section 221 includes, for example, the opening and closing valve 223 and the pressurizing section 224. The opening and closing valve 223 and the pressurizing section 224 are examples of the accommodation section 217. The opening and closing valve 223 and the pressurizing section 224 are positioned downstream of the adjustment valve 222. In the flow section 221, by passing through the adjustment valve 222, the opening and closing valve 223, and the pressurizing section 224 in this order, the liquid is supplied to the ejection section 214.

The opening and closing valve 223 is connected to the adjustment valve 222. The opening and closing valve 223 is connected to the pressurizing section 224. The opening and closing valve 223 is connected to the ejection section 214 through the pressurizing section 224. The opening and closing valve 223 is configured to open and close. The opening and closing valve 223, unlike the adjustment valve 222, is configured to open and close arbitrarily. By changing the pressure of the air chamber C22 of the opening and closing valve 223, the opening and closing valve 223 closes. When the ejection section 214 is cleaned, the opening and closing valve 223 closes. Specifically, when the pressurizing section 224 cleans the ejection section 214, the opening and closing valve 223 closes. The opening and closing valve 223 is normally open.

The pressurizing section 224 is connected to the opening and closing valve 223. The pressurizing section 224 is connected to the ejection section 214. The pressurizing section 224 is configured to pressurize the inside of the ejection section 214. By changing the pressure of the air chamber C22 of the pressurizing section 224, The pressurizing section 224 pressurizes the inside of the ejection section 214. By pressurizing the inside of the ejection section 214, the pressurizing section 224, cleans the ejection section 214. Specifically, by pressurizing the inside of the ejection section 214, the pressurizing section 224 discharges the liquid from the nozzle 216. As a result, thickened liquid, foreign matter, and the like are discharged from the ejection section 214. When the pressurizing section 224 pressurizes the inside of the ejection section 214, by the opening and closing valve 223 closing, a concern that the liquid flows backward from the pressurizing section 224 is reduced. By the opening and closing valve 223 closing, that is, choking, the pressurizing section 224 can effectively pressurize the inside of the ejection section 214.

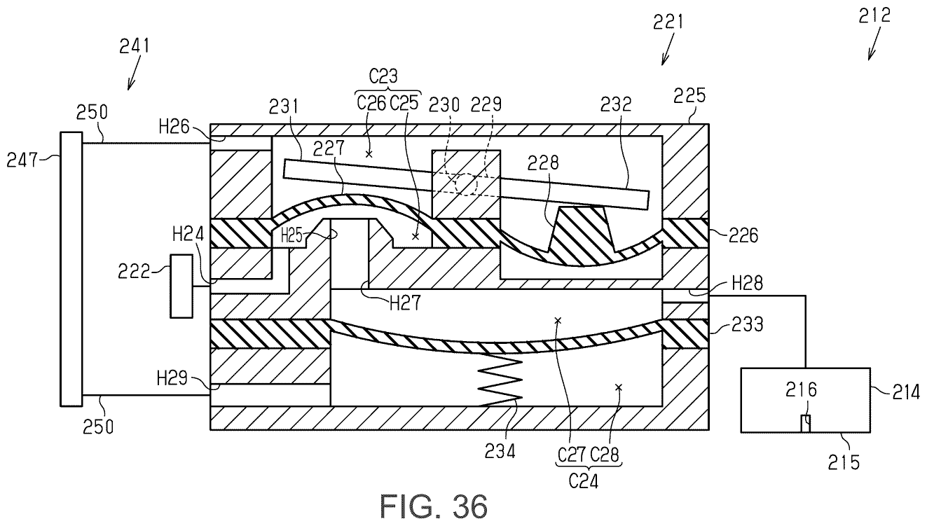

As shown in FIG. 36, the flow section 221 includes a flow member 225. The flow member 225 also defines a space for containing the liquid. The flow member 225 is a member that defines a space for containing air. In one example, the flow member 225 constitutes the opening and closing valve 223 and the pressurizing section 224. The flow member 225 may constitute the adjustment valve 222.

The flow member 225 defines a choke space C23. The choke space C23 is a space in the opening and closing valve 223. A choke inflow port H24 and a choke outflow port H25 open in the flow member 225. The choke inflow port H24 is an example of the inflow port H21. The choke outflow port H25 is an example of the pump outflow port H22. A choke air port H26 opens in the flow member 225. The choke air port H26 is an example of the air port H23.

The flow member 225 defines a pressurizing space C24. The pressurizing space C24 is a space in the pressurizing section 224. A pressurized inflow port H27 and a pressurized outflow port H28 open in the flow member 225. The pressurized inflow port H27 is an example of the inflow port H21. The pressurized outflow port H28 is an example of the pump outflow port H22. A pressurized air port H29 opens in the flow member 225. The pressurized air port H29 is an example of the air port H23.

The flow section 221 includes a choke membrane 226. The choke membrane 226 is mounted to the flow member 225. The choke membrane 226 is an example of the membrane member 218. The choke membrane 226 constitutes the opening and closing valve 223. The choke membrane 226 divides the choke space C23 into a choke liquid chamber C25 and a choke air chamber C26. The choke liquid chamber C25 is an example of the liquid chamber C21. The choke liquid chamber C25 communicates with the choke inflow port H24 and the choke outflow port H25. The choke air chamber C26 is an example of the air chamber C22. The choke air chamber C26 communicates with the choke air port H26.

The choke membrane 226 includes a valve portion 227 and a motion portion 228. The valve portion 227 is a portion that closes the choke inflow port H24 or the choke outflow port H25. In one example, valve portion 227 closes choke outflow port H25. By being pressed against a lever 229 (to be described later), the valve portion 227 closes the choke outflow port H25.5. The motion portion 228 is a portion for operating the lever 229.

The motion portion 228 is configured to be more deformable than the valve portion 227. In one example, the motion portion 228 is configured to have less elasticity than the valve portion 227. For example, the thickness of the motion portion 228 may be smaller than the thickness of the valve portion 227. The area facing the choke air chamber C26 in the motion portion 228 may be larger than the area facing the choke air chamber C26 in the valve portion 227.

When the choke air chamber C26 is depressurized, the valve portion 227 and the motion portion 228 are deformed so as to reduce the volume of the choke air chamber C26. At this time, the motion portion 228 is more easily deformed as compared with the valve portion 227.

The flow section 221 includes the lever 229. The lever 229 constitutes the opening and closing valve 223. The lever 229 is mounted to the flow member 225. The lever 229 is positioned in the choke space C23. Specifically, the lever 229 is positioned in the choke air chamber C26. The lever 229 includes, for example, a shaft portion 230. The shaft portion 230 is mounted to the flow member 225. The lever 229 is displaced around the shaft portion 230. The lever 229 is displaced in the choke air chamber C26.

The lever 229 includes a first portion 231 and a second portion 232. The first portion 231 is a portion that includes one end of the lever 229. The first portion 231 is positioned so as to be in contact with the valve portion 227. The second portion 232 is a portion that includes the other end of the lever 229. The second portion 232 is positioned so as to be in contact with the motion portion 228.

When the choke air chamber C26 is depressurized, the valve portion 227 is deformed so as to push up the first portion 231. The motion portion 228 is deformed so as to push up the second portion 232. Since the motion portion 228 is more deformable than the valve portion 227, the force by which the motion portion 228 pushes up the lever 229 is greater than the force by which the valve portion 227 pushes up the lever 229. Therefore, the lever 229 is displaced so that the first portion 231 pushes down the valve portion 227. That is, the lever 229 presses the valve portion 227 against the choke outflow port H25. As a result, the choke outflow port H25 is closed.

The flow section 221 includes a pressurizing membrane 233. The pressurizing membrane 233 is mounted to the flow member 225. The pressurizing membrane 233 is an example of the membrane member 218. The pressurizing membrane 233 constitutes the pressurizing section 224. The pressurizing membrane 233 divides the pressurizing space C24 into a pressurizing liquid chamber C27 and a pressurizing air chamber C28. The pressurizing liquid chamber C27 is an example of the liquid chamber C21. The pressurizing liquid chamber C27 communicates with the pressurized inflow port H27 and the pressurized outflow port H28. The pressurizing air chamber C28 is an example of the air chamber C22. The pressurizing air chamber C28 communicates with the pressurized air port H29.

The flow section 221 may include a pressurizing member 234. The pressurizing member 234 is configured to press the pressurizing membrane 233. Specifically, the pressurizing member 234 presses the pressurizing membrane 233 so as to reduce the volume of the pressurizing liquid chamber C27. The pressurizing member 234 is positioned in the pressurizing air chamber C28. The pressurizing member 234 is mounted to the flow member 225 and the pressurizing membrane 233.

When the pressurizing air chamber C28 is depressurized, the pressurizing membrane 233 is displaced so that the volume of the pressurizing air chamber C28 is reduced. At this time, the pressurizing membrane 233 is displaced so as to increase the volume of the pressurizing liquid chamber C27. As a result, the liquid flows into the pressurizing liquid chamber C27. Specifically, liquid flows from the ejection section 214, the adjustment valve 222, the opening and closing valve 223, and the like into the pressurizing liquid chamber C27. When the pressurizing air chamber C28 is pressurized or opened to the atmosphere, the pressurizing membrane 233 is deformed so that the volume of the pressurizing liquid chamber C27 is reduced. At this time, the liquid in the pressurizing liquid chamber C27 is pressurized. As a result, the liquid is discharged from the nozzle 216.

As shown in FIG. 34, the liquid ejection unit 212 may include a movable body 236. The movable body 236 mounts the ejection section 214 thereon. The movable body 236 mounts the flow section 221 thereon. The movable body 236 is movable. The movable body 236 moves in a scanning direction with respect to the medium M21. The liquid ejection unit 212 is a serial head capable of ejecting liquid over the entire width of the medium M21. The liquid ejection unit 212 may be a line head capable of simultaneously ejecting liquid over the entire width of the medium M21.

The liquid ejection device 211 includes a liquid supply unit 241. The liquid supply unit 241 is connected to the liquid accommodation body 213 and the liquid ejection unit 212. The liquid supply unit 241 is configured to supply the liquid to the liquid ejection unit 212.

The liquid supply unit 241 includes a supply flow path 242. The supply flow path 242 is a channel through which the liquid flows. Specifically, the supply flow path 242 is a flow path through which the liquid to be supplied to the ejection section 214 flows. The liquid is supplied to the liquid ejection unit 212 through the supply flow path 242. The supply flow path 242 is connected to the liquid accommodation body 213 and the liquid ejection unit 212. In one example, the supply flow path 242 is connected to the liquid accommodation body 213 and the flow section 221.

The liquid supply unit 241 may include a supply valve 243. In one example, the liquid supply unit 241 includes the supply valve 243. The supply valve 243 is positioned in the supply flow path 242. Specifically, the supply valve 243 is positioned between the liquid accommodation body 213 and the flow path pump 244 (to be described later). The supply valve 243 is a valve that controls the flow of the liquid in the supply flow path 242. The supply valve 243 is, for example, a one way valve. The supply valve 243, in the supply flow path 242, allows the liquid to flow from the liquid accommodation body 213 toward the liquid ejection unit 212. The supply valve 243, in the supply flow path 242, regulates the flow of liquid from the liquid ejection unit 212 toward the liquid accommodation body 213. The supply valve 243 may be a solenoid valve that is openable and closable arbitrarily.

The liquid supply unit 241 includes the flow path pump 244. The flow path pump 244 is an example of accommodation section 217. The flow path pump 244 is a so-called diaphragm pump. The flow path pump 244 is positioned in the supply flow path 242. The flow path pump 244 is positioned between the liquid accommodation body 213 and the liquid ejection unit 212. Specifically, the flow path pump 244 is positioned between the supply valve 243 and the liquid ejection unit 212. The flow path pump 244 is configured to supply liquid from the liquid accommodation body 213 to the liquid ejection unit 212. By changing the air chamber C22 of the flow path pump 244, the flow path pump 244 supplies the liquid from the liquid accommodation body 213 toward the liquid ejection unit 212.

The flow path pump 244 includes a diaphragm 245, which is an example of a membrane member. The diaphragm 245 divides the flow path pump 244 into a flow path liquid chamber C211 and a flow path air chamber C212. The flow path liquid chamber C211 is an example of the liquid chamber C1. The flow path air chamber C212 is an example of the flow path air chamber C22.

The flow path pump 244 includes a pressing member 246. The pressing member 246 is configured to press the diaphragm 245. Specifically, the pressing member 246 presses the diaphragm 245 so as to reduce the volume of the flow path liquid chamber C211. That is, the pressing member 246 presses the diaphragm 245 so as to pressurize the flow path liquid chamber C211. The pressing member 246 is positioned on the flow path air chamber C212.

When the flow path air chamber C212 is depressurized, the diaphragm 245 deforms so as to increase the volume of the flow path liquid chamber C211. As a result, the liquid flows from the liquid accommodation body 213 into the flow path liquid chamber C211. When the flow path air chamber C212 is pressurized or opened to the atmosphere, the diaphragm 245 is deformed so that the volume of the flow path liquid chamber C211 is reduced by the pressing member 246. As a result, the liquid flows out from the flow path liquid chamber C211 toward the flow section 221.

The liquid supply unit 241 includes a pressure changing unit 247. The pressure changing unit 247 is connected to the accommodation section 217. In one example, the pressure changing unit 247 is connected to each of the opening and closing valve 223, the pressurizing section 224, and the flow path pump 244.

The pressure changing unit 247 is configured to change the pressure of the accommodation section 217. In one example, the pressure changing unit 247 is configured to change the pressure of an arbitrary accommodation section 217 among the plurality of accommodation sections 217. The pressure changing unit 247 changes the pressure in the air chamber C22. In one example, the pressure changing unit 247 decompresses the air chamber C22.

The pressure changing unit 247 includes a decompression pump 248. The decompression pump 248 is a pump that generates a negative pressure. The decompression pump 248 is connected to the accommodation section 217. The decompression pump 248 depressurizes the air chamber C22.

The pressure changing unit 247 includes a motor 249. The motor 249 is connected to the decompression pump 248. The motor 249 causes the decompression pump 248 to drive. In other words, the decompression pump 248 is driven by the power of the motor 249. The motor 249 is operated, for example, by PWM control.

The liquid supply unit 241 includes an air flow path 250. The air flow path 250 is connected to the pressure changing unit 247 and the accommodation section 217. In one example, the air flow path 250 is connected to the decompression pump 248 and the opening and closing valve 223. The air flow path 250 is connected to the decompression pump 248 and the pressurizing section 224. The air flow path 250 is connected to the decompression pump 248 and the flow path pump 244. Through the air flow path 250 the air chamber C22 is depressurized by the decompression pump 248.

The liquid supply unit 241 includes one or more air valves. In one example, the liquid supply unit 241 includes a first air valve 251, a second air valve 252, and a third air valve 253. The air valve is positioned in the air flow path 250. The air valve is configured to open and close. The air valve is, for example, a solenoid valve. The first air valve 251 is positioned between the decompression pump 248 and the opening and closing valve 223. When the first air valve 251 is opened the opening and closing valve 223 can be depressurized by the decompression pump 248. The second air valve 252 is positioned between the decompression pump 248 and the pressurizing section 224. When the second air valve 252 is opened the pressurizing section 224 can be depressurized by the decompression pump 248. The third air valve 253 is positioned between the decompression pump 248 and the flow path pump 244. When the third air valve 253 is opened the flow path pump 244 can be depressurized by the decompression pump 248.

The liquid supply unit 241 includes an air release valve 254. The air release valve 254 is connected to the air flow path 250. The air release valve 254 is configured to open and close. The air release valve 254 is, for example, a solenoid valve. When the air release valve 254 is opened, the air flow path 250 is opened to the atmosphere. Through the air flow path 250, the accommodation section 217 is opened to the atmosphere. Specifically, when the air release valve 254 and the first air valve 251 are opened, the opening and closing valve 223 is opened to the atmosphere. When the air release valve 254 and the second air valve 252 are opened, the pressurizing section 224 is opened to the atmosphere. When the air release valve 254 and the third air valve 253 are opened, the flow path pump 244 is opened to the atmosphere.

The liquid ejection device 211 includes a power supply circuit 256. The power supply circuit 256 is connected to the liquid supply unit 241. The power supply circuit 256 is connected to the pressure changing unit 247. The power supply circuit 256 is connected to the motor 249. The power supply circuit 256 applies a voltage to the motor 249. The power supply circuit 256 applies an arbitrary voltage to the motor 249. By the power supply circuit 256 applying a voltage to the motor 249, the motor 249 starts.

The liquid ejection device 211 includes a control section 257. The control section 257 controls the liquid supply unit 241. The control section 257 controls the pressure changing unit 247. The control section 257 controls the power supply circuit 256. By controlling the power supply circuit 256, the control section 257 controls the applied voltage of the motor 249. The control section 257 controls the applied voltage by PWM control. By controlling the applied voltage, the control section 257 controls the decompression pump 248. As a result, the control section 257 controls the negative pressure generated by the decompression pump 248.

The control section 257 controls the air valve. By controlling the air valve, the control section 257 controls the operation of the accommodation section 217. The control section 257 controls the air release valve 254. By controlling the air release valve 254, the control section 257 controls the operation of the accommodation section 217. By controlling the air valve and the air release valve 254, the control section 257 causes the arbitrary accommodation section 217 to decompress or open to the atmosphere. As a result, the control section 257 controls the flow of the liquid.

By controlling the operations of the opening and closing valve 223 and the pressurizing section 224, the control section 257 executes cleaning. In one example, first, the control section 257 opens the second air valve 252. Next, the control section 257 starts the motor 249. As a result, the pressurizing air chamber C28 is depressurized by the decompression pump 248. As a result, the liquid flows into the pressurizing liquid chamber C27. Next, the control section 257 closes the second air valve 252. As a result, the pressurizing air chamber C28 is maintained at the negative pressure. Next, the control section 257 opens the first air valve 251. As a result, the choke air chamber C26 is depressurized by the decompression pump 248. As a result, the opening and closing valve 223 is closed. Next, the control section 257 opens the second air valve 252 and the air release valve 254. As a result, the pressurizing air chamber C28 is opened to the atmosphere. As a result, the liquid is discharged from the nozzle 216.

By controlling the flow path pump 244, the control section 257 supplies the liquid to the liquid ejection unit 212. In one example, first, the control section 257 opens the third air valve 253. Next, the control section 257 starts the motor 249. As a result, the flow path air chamber C212 is depressurized by the decompression pump 248. As a result, the liquid flows from the liquid accommodation body 213 into the flow path liquid chamber C211. Next, the control section 257 opens the air release valve 254. As a result, the flow path air chamber C212 is opened to the atmosphere. As a result, the diaphragm 245 pressurizes the liquid in the flow path liquid chamber C211. Therefore, the liquid flows out from the flow path liquid chamber C211 toward the liquid ejection unit 212.

The control section 257 is not limited to the liquid supply unit 241, and may control the liquid ejection unit 212. The control section 257 may integrally control the liquid ejection device 211. The control section 257 may be configured by one or more processors that execute various processes in accordance with a computer program. The control section 257 may be configured by one or more dedicated hardware circuits such as an ASIC that executes at least a part of various processes. The control section 257 may be configured by a circuit including a combination of a processor and a hardware circuit. The processor includes a CPU and memory such as RAM and ROM. The memory stores program codes or instructions configured to cause the CPU to execute the processing. The memory, that is, computer-readable medium includes any readable medium that can be accessed by a general-purpose or dedicated computer.

### Control of the Applied Voltage

Next, the control of the applied voltage by control section 257 will be described. When choking is performed by the opening and closing valve 223, the control section 257 causes the motor 249 to drive at a target voltage. When the ejection section 214 is cleaned by the pressurizing section 224, the control section 257 causes the motor 249 to drive at a target voltage. When the liquid is supplied to the ejection section 214 by the flow path pump 244, the control section 257 causes the motor 249 to drive at a target voltage. By the motor 249 driving at the target voltage, the accommodation section 217 can be sufficiently depressurized.

When the accommodation section 217 is depressurized, the negative pressure of the accommodation section 217 may act on the ejection section 214. Therefore, when the accommodation section 217 is rapidly depressurized, the meniscus of the nozzle 216 may be broken. In one example, when the pressurizing section 224 is depressurized, the negative pressure of the pressurizing section 224 acts on the ejection section 214 until the adjustment valve 222 is opened. If the pressurizing section 224 is rapidly depressurized, the meniscus of the nozzle 216 may be broken. Therefore, by controlling the applied voltage to the motor 249, the control section 257 decompresses the accommodation section 217 so as not to break the meniscus.

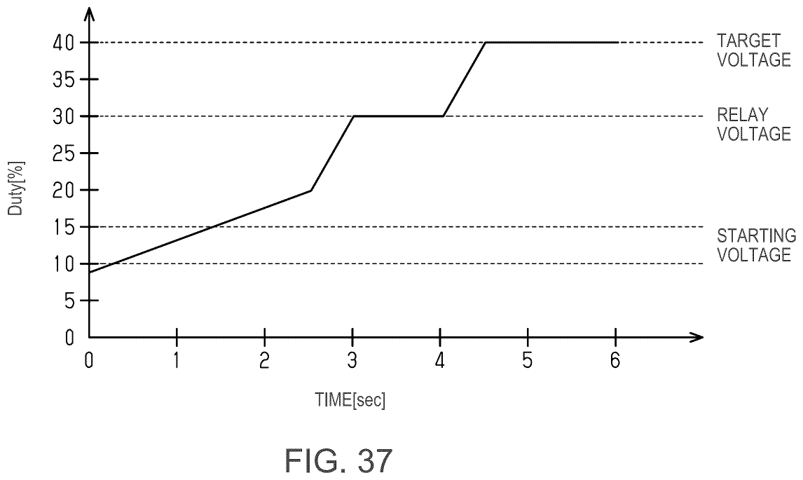

As shown in FIG. 37, the control section 257 gradually increases the applied voltage until the applied voltage of the motor 249 reaches the target voltage. Specifically, by increasing the applied voltage over a predetermined period of time, the control section 257 causes the applied voltage to reach the target voltage. As a result, the decompression pump 248 gradually depressurizes the pressurizing section 224. Therefore, the possibility of breaking the meniscus is reduced. The control section 257 performs, for example, PWM control on the applied voltage of the motor 249. By controlling the duty cycle by the power supply circuit 256, the control section 257 controls the applied voltage of the motor 249.

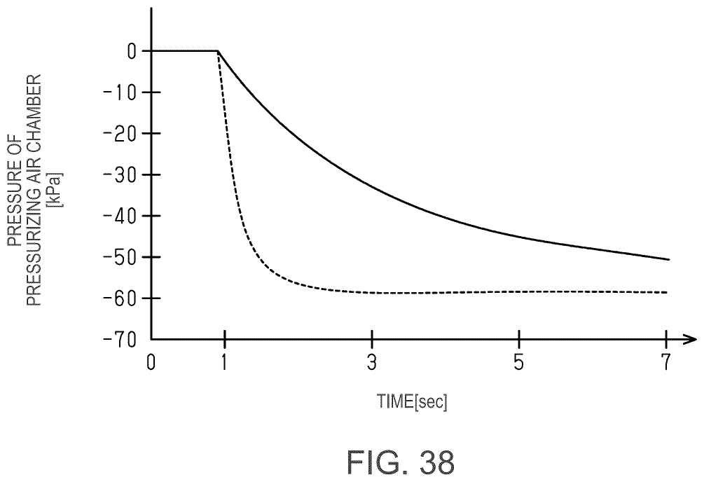

As shown in FIG. 38, by the control section 257 gradually increasing the applied voltage, the pressurizing air chamber C28 is gradually depressurized. The graph is indicated by the solid line in FIG. 38 shows the pressure transition of the pressurizing air chamber C28 when the applied voltage is gradually increased. The graph is indicated by the dashed line in FIG. 38 shows the pressure transition of the pressurizing air chamber C28 when the applied voltage is made to immediately reach the target voltage.

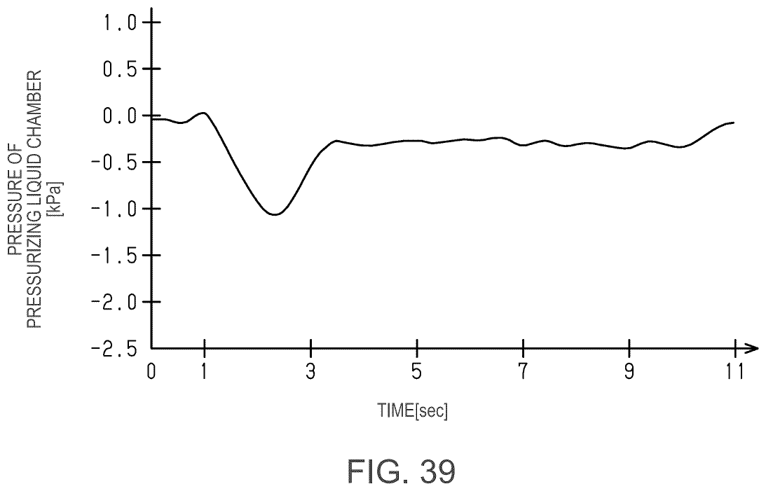

As shown in FIG. 39, by the control section 257 gradually increasing the applied voltage, the pressurizing liquid chamber C27 is depressurized so that the pressure in the pressurizing liquid chamber C27 does not exceed the meniscus pressure resistance. The meniscus pressure resistance is, for example, −2.0 kPa. The operating pressure of the adjustment valve 222 is, for example, −1.0 kPa. In the graph shown in FIG. 39, the pressure in the pressurizing liquid chamber C27 is transitioned so as to rise after falling below −1.0 kPa. This is because, by the adjustment valve 222 opening, the liquid flowed into the pressurizing liquid chamber C27.

The control section 257 gradually increases the applied voltage until the applied voltage reaches the target voltage so that the pressure in the ejection section 214 when the air chamber C22 is depressurized by the decompression pump 248 does not fall below the meniscus pressure resistance. In one example, the control section 257 gradually increases the applied voltage so that the pressure in the ejection section 214 when the pressurizing air chamber C28 is depressurized by the decompression pump 248 does not fall below −2.0 KPa. The pressure in the ejection section 214 is normally maintained at the operating pressure of the adjustment valve 222. Therefore, the pressure in the ejection section 214 is normally −1.0 KPa. That is, the control section 257 gradually increases the applied voltage so that the negative pressure acting on the inside of the ejection section 214 by the decompression pump 248 does not exceed −1.0 kPa. The control section 257 gradually increases the applied voltage so that the sum of the negative pressure and the operating pressure acting in the ejection section 214 by the decompression pump 248 does not exceed the meniscus pressure resistance.

As shown in FIG. 37, the control section 257 controls so as to gradually increase the applied voltage from the voltage lower than the starting voltage of the motor 249. Specifically, the control section 257 controls so as to gradually increase the applied voltage from a voltage lower than a starting voltage band. That is, the control section 257 lowers the application start voltage applied to the motor 249 than the starting voltage. The starting voltage is the voltage at which the motor 249 starts to rotate. The starting voltage band is a voltage band indicating the range of the starting voltage. In the motor 249, there is a variation in the starting voltage. The application start voltage is the applied voltage at the start of the application. By the applied voltage increasing from a voltage lower than the starting voltage, a concern that the motor 249 starts to rotate vigorously immediately after the start of the application is reduced. That is, a concern that the pressurizing section 224 is rapidly depressurized by the motor 249 having a small starting voltage is reduced.

The control section 257, until a predetermined time has elapsed since the start of applying a voltage to the motor 249, increases the applied voltage at a constant inclination. The predetermined time is the time until the applied voltage becomes larger than the starting voltage. Specifically, the predetermined time is the time required until the negative pressure by the decompression pump 248 acts on the accommodation section 217. By elapsing the predetermined time, regardless of the variation of the starting voltage, the motor 249 is started. Immediately after the start of the motor 249, the negative pressure by the decompression pump 248 may not act on the pressurizing air chamber C28. Therefore, the predetermined time needs to be longer than the time required for the applied voltage to reach the starting voltage. By the predetermined time elapsing in a state where the inclination of the applied voltage is maintained constant, the decompression pump 248 can slowly reduce the pressure of the pressurizing air chamber C28.

The control section 257, after elapsing the predetermined time, increases the inclination of the applied voltage. As a result, the time required for the applied voltage to reach the target voltage is shortened.

The control section 257, after increasing the inclination of the applied voltage, maintains the applied voltage at a relay voltage lower than the target voltage for a certain period of time. After increasing the inclination of the applied voltage, when the voltage is rapidly increased to the target voltage, the negative pressure in the ejection section 214 may exceed the meniscus pressure resistance. By waiting in a state in which the applied voltage is the relay voltage, a concern that the pressurizing section 224 is rapidly depressurized is reduced.

The control section 257, after waiting in a state in which the applied voltage is the relay voltage for a certain period of time, increases the applied voltage at a certain inclination. The control section 257, for example, increases the applied voltage from the relay voltage to the target voltage at the same inclination as the inclination after the predetermined time has elapsed. As a result, the time required for the applied voltage to reach the target voltage is shortened. The applied voltage is changed stepwise by the relay voltage. The control section 257 may transition the applied voltage so that the applied voltage passes through a plurality of relay voltages.

### Operation and Effect of Embodiment

Next, the operation and effects of the above embodiment will be described.

(15) The control section 257 gradually increases the applied voltage until the applied voltage of the motor 249 reaches the target voltage. According to the above described configuration, since the air chamber C22 is gradually depressurized, a concern that the liquid rapidly flows from the ejection section 214 to the liquid chamber C21 is reduced. Therefore, a concern that air flowing from the nozzle 216 into the ejection section 214 is reduced.

(16) The control section 257 increases the applied voltage from the voltage smaller than the starting voltage of the motor 249. Usually, the starting voltage of the motor 249 varies. According to the above described configuration, a concern that the motor 249 starts immediately after the voltage application to the motor 249 is started is reduced. Therefore, even when there is a variation in the starting voltage of the motor 249, a concern that the air chamber C22 is rapidly decompression is reduced.

(17) The control section 257, until a predetermined time has elapsed since the start of applying a voltage to the motor 249, increases the applied voltage at a constant inclination. According to the above described configuration, even when the starting voltage of the motor 249 varies, a concern that the air chamber C22 is rapidly depressurized is reduced.

(18) The control section 257, after elapsing the predetermined time, increases the inclination of the applied voltage. According to the above described configuration, the time required for the applied voltage to reach the target voltage is shortened as compared with the case where the inclination of the applied voltage remains constant.

(19) The control section 257, after increasing the inclination of the applied voltage, maintains the applied voltage at a relay voltage lower than the target voltage for a certain period of time. When the inclination of the applied voltage becomes large, the air chamber C22 may be rapidly decompressed. In this case, air may flow into the ejection section 214 from the nozzle 216. In this regard, according to the above described configuration, since the applied voltage is maintained at the relay voltage for a certain period of time, a concern that the air chamber C22 is rapidly depressurized is reduced.

(20) The flow section 221 includes the accommodation section 217. According to the above described configuration, the flow of the liquid supplied to the ejection section 214 can be controlled by the accommodation section 217.

(21) The operating pressure of the adjustment valve 222 is larger than the meniscus pressure resistance. According to the above described configuration, the adjustment valve 222 is opened before the pressure in the liquid chamber C1 falls below the meniscus pressure resistance. Therefore, a concern that air flowing from the nozzle 216 into the ejection section 214 is reduced.

### Modifications

The embodiment can be modified as follows. The above described embodiments and the following modifications can be implemented in combination with each other to the extent that they are not technically contradictory.
The bundling member 175 is not limited to the liquid ejection unit 22 and may be applied to a flexible member connected to another unit. That is, a bundling member 175 may be used to hold together a plurality of flexible members connected to a unit moving in the scanning direction D1. The bundling member 175 may be used to bundle, for example, signal lines, flexible flat cables, and the like connected to the unit.

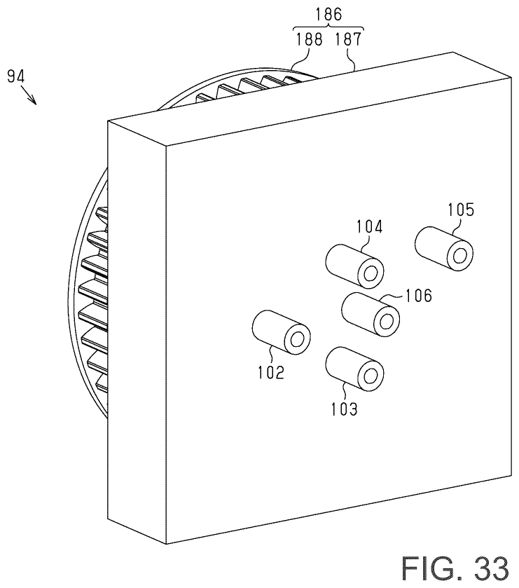

As shown in FIG. 33, the switching section 94 may include a switching body 186. In this modification, the switching section 94 includes the switching body 186 instead of the flow path member 95. The switching body 186 is positioned between the first pump 93 and the plurality of connect destinations of the pressure changing unit 81. The switching body 186 is configured to, by rotating, switch the connection between the plurality of connect destinations and the first pump 93. In the switching body 186, similarly to the flow path member 95, the pump path P1, the reverse path P2, the pressurized path P3, the choke path P4, and the connection path P5 are defined.

The switching body 186 includes a switching substrate 187 and a rotating body 188. The switching substrate 187 includes a plurality of switching pipes in the same manner as the flow path substrate 96. The switching substrate 187 includes the pump pipe 102, the flow path pump pipe 103, the release tube 104, the pressurizing tube 105, and the choke tube 106. The rotating body 188 is in close contact with the switching substrate 187. The rotating body 188 rotates while in close contact with the switching substrate 187. When the rotating body 188 rotates, the connection of the pump pipe 102, the flow path pump pipe 103, the release tube 104, the pressurizing tube 105, and the choke tube 106 are switched. For example, when the rotating body 188 rotates, it switches from a state in which the pump pipe 102 and the pressurizing tube 105 are connected to a state in which the pump pipe 102 and the choke tube 106 are connected. According to such the switching body 186, it is possible to switch the connection between the plurality of connect destinations and the first pump 93 with a relatively simple configuration.
The liquid ejected by the ejection section 23 is not limited to ink, and may be, for example, a liquid material in which particles of a functional material are dispersed or mixed in a liquid. For example, the ejection section 23 may eject the liquid material containing a material such as an electrode material or a pixel material used for manufacturing a liquid crystal display, an electroluminescence display, a surface emitting display, or the like in a dispersed or dissolved form.
In the liquid ejection device 211, at least a part of the adjustment valve 222, the opening and closing valve 223, and the pressurizing section 224 may be provided in the supply flow path 242. That is, one of the adjustment valve 222, the opening and closing valve 223, and the pressurizing section 224 may be provided in the supply flow path 242, two of the adjustment valve 222, the opening and closing valve 223, and the pressurizing section 224 may be provided in the supply flow path 242, or all of the adjustment valve 222, the opening and closing valve 223, and the pressurizing section 224 may be provided in the supply flow path 242.
In the liquid ejection device 211, the inside of the ejection section 214 may be maintained at a negative pressure not only by the adjustment valve 222 but also by, for example, a water head difference. In this case, the flow section 221 does not have the adjustment valve 222. In this modification, the pressure in the flow path pump 244 acts on the inside of the ejection section 214. Therefore, the control section 257, when driving the flow path pump 244, may gradually increase the applied voltage. According to this modification, a concern that air flowing from the nozzle 216 into the ejection section 214 is reduced. The liquid in the ejection section 214 can be returned to the supply flow path 242. As a result, the liquid can be agitated.
The liquid ejected by the ejection section 214 is not limited to ink, and may be, for example, a liquid material in which particles of a functional material are dispersed or mixed in a liquid. For example, ejection section 214 may eject the liquid material containing a material such as an electrode material or a pixel material used for manufacturing a liquid crystal display, an electroluminescence display, a surface emitting display, or the like in a dispersed or dissolved form.

### Technical Concept

Hereinafter, technical concepts grasped from the above described embodiments and modifications and operations and effects thereof, will be described.

(1) The pressure changing unit is a pressure changing unit used to change the plurality of connect destinations, the pressure changing unit includes a motor; a pump that is connected to the motor and that is driven by power of the motor; a switching section configured to switch connection between the plurality of connect destinations and the pump by the power of the motor; and a transmission section positioned between the motor and the switching section, wherein the transmission section is configured to, when the motor rotates in a forward direction, not transmit power from the motor to the switching section and, when the motor rotates in a reverse direction, transmit power from the motor to the switching section.

According to the above described configuration, driving of the pump and driving of the switching section are executed by one motor. As a result, a concern that the pressure changing unit becoming larger is reduced.

(2) The pressure changing unit, may be such that
the switching section includes plurality of valves positioned between the plurality of connect destinations and the pump and a plurality of cams configured to open and close each of the plurality of valves.

According to the above described configuration, it is possible to switch the connection between the plurality of connect destinations and the pump with a relatively simple configuration.

(3) The pressure changing unit, may be such that the switching section includes a switching body that is positioned between the plurality of connect destinations and the pump and that is configured to, by rotating, switch the connection between the plurality of connect destinations and the pump.

According to the above described configuration, it is possible to switch the connection between the plurality of connect destinations and the pump with a relatively simple configuration.

(4) The pressure changing unit, may be such that the transmission section includes a one way clutch.

According to the above described configuration, with a relatively simple configuration, when the motor rotates in the forward direction, it is possible not to transmit power from the motor to the switching section and when the motor rotates in the reverse direction, it is possible to transmit power from the motor to the switching section.

(5) The pressure changing unit, may be such that the motor is a first motor, the pump is a first pump, the transmission section is a first transmission section, the pressure changing unit includes a second motor, a second pump that is connected to the second motor and that is driven by the power of the second motor, an air release section that is connected to the plurality of connect destinations and that is configured to open the plurality of connect destinations to atmosphere, and a second transmission section that is positioned between the second motor and the air release section and that is configured to transmit the power of the second motor to the air release section, the second pump is configured to change the pressure of at least one of the connect destinations among the plurality of connect destinations, and the air release section is configured to close, when the second motor rotates in the forward direction and to open when the second motor rotates in the reverse direction.

According to the above described configuration, the driving of the second pump and the opening and closing of the air release section are executed by one second motor. the pressure at the connect destination can be changed by the first pump and the second pump and the pressure at the connect destination can be returned to atmospheric pressure by the air release section. In this way, it is possible to change the pressure of the connect destination more freely.

(6) The pressure changing unit, may further include a detection section configured to detect rotation angle of the motor and a control section configured to control the motor, wherein the control section when causing the motor to rotate in the forward direction, open controls the motor and when causing the motor to rotate in the reverse direction, PID controls the motor based on a detection result by the detection section.

According to the above described configuration, by the motor is PID controlled, it is possible to switch the connection between the multiple connect destinations and the pump with high accuracy.

(7) A liquid ejection device includes a liquid ejection unit configured to eject liquid and a liquid supply unit configured to supply liquid to the liquid ejection unit, wherein the liquid supply unit includes a supply flow path through which liquid flows toward the liquid ejection unit and the pressure changing unit, at least either the liquid supply unit or the liquid ejection unit includes an accommodation section configured to accommodate liquid, the accommodation section includes a membrane member configured to divide the inside of the accommodation section into an air chamber and a liquid chamber, the plurality of connect destinations includes the accommodation section, and the pressure changing unit is configured to change pressure in the air chamber.

According to the above described configuration, by the pressure changing unit changing the pressure of the air chamber, the pressure of the liquid chamber changes. For example, when the liquid chamber is pressurized, the liquid is discharged from the liquid chamber. When the liquid chamber is depressurized, the liquid flows into the liquid chamber. In this way, by changing the pressure of the air chamber, the pressure changing unit can control the flow of the liquid.

(8) The liquid ejection device, may be such that the accommodation section is one of a plurality of accommodation sections, each of the plurality of accommodation sections includes an air chamber, each of the plurality of accommodation sections is provided in the liquid supply unit or in the liquid ejection unit, the plurality of connect destinations includes the plurality of accommodation sections, and the pressure changing unit selectively changes the pressure of the plurality of air chambers.

According to the above described configuration, the pressure changing unit can finely control the flow of the liquid.

(9) The liquid ejection device, may further include a frame configured to support the pressure changing unit and a fixing member configured to fix the pressure changing unit to the frame, wherein the fixing member is configured to be attached to and detached from the pressure changing unit and the frame from above.

According to the above described configuration, by accessing the fixing member from above, the pressure changing unit can be easily attached to and detached from with respect to the frame.

(10) The liquid ejection device, may be such that the liquid supply unit includes an air flow path connected to the accommodation section and the pump, the liquid ejection unit includes an ejection section configured to eject liquid, a movable body that has mounted thereon the ejection section and that is movable in a scanning direction, and a flow section mounted on the movable body and connected to the supply flow path and the ejection section, the flow section includes the accommodation section, the supply flow path includes a first flexible member that deforms in accordance with movement of the liquid ejection unit in the scanning direction, the air flow path includes a second flexible member that deforms in accordance with movement of the liquid ejection unit in the scanning direction, and an upstream end of the first flexible member and an upstream end of the second flexible member are positioned on one side with respect to a center of a movement region of the liquid ejection unit.

According to the above described configuration, the upstream end of the first flexible member and the upstream end of the second flexible member are disposed of collectively. The first flexible member and the second flexible member extend toward the flow section. Therefore, a concern that the length of the first flexible member and the length of the second flexible member greatly deviate from each other is reduced. By the length of the first flexible member and the length of the second flexible member are close to each other, the first flexible member and the second flexible member are easily aligned with each other. As a result, the space occupied by the first flexible member and the second flexible member can be reduced.

(11) The liquid ejection device, may be such that further includes a bundling member that bundles the first flexible member and the second flexible member, wherein the bundling member includes a holding section configured to hold the first flexible member and a support section configured to support the second flexible member and the support section includes a pulley configured to contact the second flexible member.

According to the above described configuration, a concern that the second flexible member is damaged by friction with the first flexible member and the bundling member is reduced.

(12) The bundling member is a bundling member that bundles the plurality of flexible members connected to a unit that moves in the scanning direction, wherein the plurality of flexible members include a first flexible member and a second flexible member, the bundling member includes a holding section configured to hold the first flexible member and a support section configured to support the second flexible member so that the second flexible member is movable, and the support section includes a pulley configured to contact the second flexible member.

According to the above described configuration, by contacting the pulley, the second flexible member is supported. By the pulley rotation, the concern that the second flexible member will wear out is reduced. Since the first flexible member is held by the holding section, there is no concern that the first flexible member will be worn out by contact with the holding section. Therefore, wear of the flexible member is reduced.

(13) In the bundling member, the pulley may include flanges at both axial ends.

According to the above described configuration, the flanges reduce portions where the second flexible member contacts other than the pulley.

(14) The liquid supply unit is a liquid supply unit that supplies liquid to the liquid ejection unit that ejects liquid, the liquid supply unit includes the bundling member and the plurality of flexible members, wherein the unit is the liquid ejection unit and the first flexible member is a liquid tube that supplies liquid to the liquid ejection unit.

According to the above described configuration, the bundling member can hold the liquid tube.

(15) The liquid supply unit may be such that the second flexible member is the air tube that supplies air to the liquid ejection unit.

According to the above described configuration, a concern of wearing out the air tube is reduced.

(16) The liquid supply unit is the liquid supply unit that supplies liquid to the liquid ejection unit that ejects liquid, the liquid supply unit including the bundling member and the plurality of flexible members, wherein the unit is the liquid ejection unit, the first flexible member is a liquid tube that supplies liquid to the liquid ejection unit, and the second flexible member is an air tube that supplies air to the liquid ejection unit.

According to the above described configuration, the bundling member can hold the liquid tube and a concern that the air tube will wear out is reduced.

(17) The liquid supply unit may be such that the liquid tube includes the extended portion extending in the scanning direction and the bending portion bent in an arc shape from the extended portion toward the liquid ejection unit, the holding section holds the extended portion, and the support section supports the air tube at a position closer to the liquid ejection unit than the holding section.

According to the above described configuration, by the support section supporting the air tube at a position closer to the liquid ejection unit than the holding section, the curvature of the air tube becomes larger than that of the liquid tube. The material for the air tube can be selected more for its good bending property than for its barrier property, compared with the liquid tube. Therefore, even if the curvature of the air tube becomes larger than that of the liquid tube, there is no problem. By the support section supporting the air tube at a position closer to the liquid ejection unit than the holding section, the space occupied by the space occupied by the air tube and the liquid tube can be reduced.

(18) The liquid ejection device includes the liquid supply unit and the liquid ejection unit.

According to the above described configuration, it is possible to reduce the wear of the flexible member in the liquid ejection device.

(19) The liquid ejection device may be such that the liquid ejection unit includes the ejection section for discharging the liquid, the movable body that has mounted thereon the ejection section and that is movable in the scanning direction, and the flow section mounted on the movable body and connected to the first flexible member, the flow section includes the accommodation section configured to accommodate the liquid, the accommodation section includes the membrane member configured to divide the inside of the accommodation section into the liquid chamber and the air chamber, the liquid supply unit includes the pressure changing unit, the first flexible member communicates with the liquid chamber, the second flexible member communicates with the air chamber, and the pressure changing unit is configured to change pressure in the air chamber.

According to the above described configuration, when the pressure in the air chamber changes, the pressure in the liquid chamber changes. For example, when the liquid chamber is pressurized, the liquid is discharged from the liquid chamber. When the liquid chamber is depressurized, the liquid flows into the liquid chamber. In this way, by the pressure changing unit changing the pressure of the air chamber, the flow of the liquid can be controlled.

(20) The liquid ejection device may be such that an upstream end of the first flexible member and an upstream end of the second flexible member are positioned on one side with respect to a center of a movement region of the liquid ejection unit.

According to the above described configuration, the upstream end of the first flexible member and the upstream end of the second flexible member are disposed of collectively. The first flexible member and the second flexible member extend toward the flow section. Therefore, a concern that the length of the first flexible member and the length of the second flexible member greatly deviate from each other is reduced. By the length of the first flexible member and the length of the second flexible member are close to each other, the first flexible member and the second flexible member are easily aligned with each other. As a result, the space occupied by the first flexible member and the second flexible member can be reduced.

(21) A liquid ejection device includes an ejection section configured to eject liquid from a nozzle, an accommodation section connected to the ejection section, a pressure changing unit connected to the accommodation section, and a control section configured to control the pressure changing unit, wherein the accommodation section includes a membrane member configured to divide the inside of the accommodation section into an air chamber and a liquid chamber, the liquid chamber communicates with the ejection section, the air chamber communicates with the pressure changing unit, the pressure changing unit includes a decompression pump configured to decompress the air chamber and a motor configured to drive the decompression pump, and the control section gradually increases the applied voltage until the applied voltage of the motor reaches the target voltage.

According to the above described configuration, since the air chamber is gradually depressurized, a concern that the liquid will rapidly flow from the ejection section to the liquid chamber is reduced. Therefore, a concern that air will flow into the ejection section from the nozzle is reduced.

(22) The liquid ejection device may be such that the control section increases the applied voltage from the voltage to smaller than the starting voltage of the motor. Usually, the starting voltage of the motor varies.

According to the above described configuration, a concern is reduced that the motor will start immediately after application of applied voltage to the motor is started. Therefore, even when the starting voltage of the motor varies, a concern that the air chamber will be rapidly depressurized is reduced.

(23) The liquid ejection device may be such that the control section increases the applied voltage at a constant inclination, until a predetermined time has elapsed since the start of applying voltage to the motor.

According to the above described configuration, even when the starting voltage of the motor varies, a concern that the air chamber is rapidly depressurized is reduced.

(24) The liquid ejection device may be such that the control section increases the inclination of the applied voltage after the predetermined time has elapsed.

According to the above described configuration, the time required for the applied voltage to reach the target voltage is shortened as compared with the case where the inclination of the applied voltage remains constant.

(25) The liquid ejection device may be such that the control section, after increasing the inclination of the applied voltage, maintains the applied voltage at a relay voltage lower than the target voltage for a certain period of time.

When the inclination of the applied voltage becomes large, the air chamber may be rapidly decompressed. In this case, air may flow into the ejection section from the nozzle.

In this regard, according to the above described configuration, since the applied voltage is maintained at the relay voltage for a certain period of time, a concern that the air chamber is rapidly depressurized is reduced.

(26) The liquid ejection device may further include a movable body that has mounted thereon the ejection section and that is movable, a supply flow path through which the liquid to be supplied to the ejection section flows, and a flow section that is mounted on the movable body and that is connected to the supply flow path and the ejection section, wherein the flow section includes the accommodation section.

According to the above described configuration, it is possible to control the flow of liquid supplied to the ejection section by the accommodation section.

(27) The liquid ejection device may further include a movable body that has mounted thereon the ejection section and that is movable, a supply flow path through which the liquid to be supplied to the ejection section flows, and a flow section that is mounted on the movable body and that is connected to the supply flow path and the ejection section, wherein the accommodation section is positioned in the supply flow path.

According to the above described configuration, the liquid in the ejection section can be returned to the supply flow path.

(28) In the liquid ejection device, may be such that the flow section includes an adjustment valve positioned upstream of the accommodation section, the adjustment valve is configured to open when the pressure of the liquid chamber becomes equal to or lower than a predetermined pressure and the predetermined pressure is larger than a withstanding pressure of a meniscus which is formed in the nozzle.

According to the above described configuration, the adjustment valve is opened before the pressure in the liquid chamber falls below the withstanding pressure of a meniscus. Therefore, a concern that air will flow into the ejection section from the nozzle is reduced.

(29) A control method of a liquid ejection device, the liquid ejection device including a pressure changing unit that includes an ejection section configured to eject a liquid from a nozzle, a supply flow path through which the liquid to be supplied to the ejection section flows, and a flow section connected to the supply flow path and the ejection section for controlling the flow of the liquid supplied to the ejection section and that connected to the flow section and a control section configured to control the pressure changing unit, wherein the flow section includes a membrane member configured to divide a flow space in the flow section into an air chamber and a liquid chamber, and an adjustment valve positioned upstream of the liquid chamber, the liquid chamber communicates with the ejection section, the air chamber communicates with the pressure changing unit, the pressure changing unit includes a decompression pump configured to decompress the air chamber and a motor configured to drive the decompression pump, and the adjustment valve is configured to open when the pressure of the liquid chamber becomes equal to or lower than a predetermined pressure, the control method of a liquid ejection device including gradually increasing the applied voltage until the applied voltage of the motor reaches the target voltage.

According to the above described method, the same effects as those of the above described liquid ejection device can be obtained.

(30) The method of controlling the liquid ejection device, may include increasing the applied voltage from the voltage smaller than the starting voltage of the motor.

According to the above described method, the same effects as those of the above described liquid ejection device can be obtained.

What is claimed is:

1. A pressure changing unit for changing pressures at a plurality of connect destinations, the pressure changing unit comprising:
a motor;
a pump that is connected to the motor and that is driven by power of the motor;
a switching section configured to switch connection between the plurality of connect destinations and the pump by the power of the motor; and
a transmission section positioned between the motor and the switching section, wherein
the transmission section is configured to, when the motor rotates in a forward direction, not transmit power from the motor to the switching section and, when the motor rotates in a reverse direction, transmit power from the motor to the switching section.

2. The pressure changing unit according to claim 1, wherein
the switching section includes
a plurality of valves positioned between the plurality of connect destinations and the pump and
a plurality of cams configured to open and close each of the plurality of valves.

3. The pressure changing unit according to claim 1, wherein
the switching section includes a switching body that is positioned between the plurality of connect destinations and the pump and that is configured to, by rotating, switch the connection between the plurality of connect destinations and the pump.

4. The pressure changing unit according to claim 1, wherein
the transmission section includes a one way clutch.

5. The pressure changing unit according to claim 1, wherein
the motor is a first motor,
the pump is a first pump,
the transmission section is a first transmission section,
the pressure changing unit includes
a second motor,
a second pump that is connected to the second motor and that is driven by the power of the second motor,
an air release section that is connected to the plurality of connect destinations and that is configured to open the plurality of connect destinations to atmosphere, and
a second transmission section that is positioned between the second motor and the air release section and that is configured to transmit the power of the second motor to the air release section,
the second pump is configured to change the pressure of at least one of the connect destinations among the plurality of connect destinations, and
the air release section is configured to close, when the second motor rotates in the forward direction and to open when the second motor rotates in the reverse direction.

6. The pressure changing unit according to claim 1, further comprising:
a detection section configured to detect rotation angle of the motor and
a control section configured to control the motor, wherein
the control section
when causing the motor to rotate in the forward direction, open controls the motor and
when causing the motor to rotate in the reverse direction, PID controls the motor based on a detection result by the detection section.

7. A liquid ejection device comprising:
a liquid ejection unit configured to eject liquid and
a liquid supply unit configured to supply liquid to the liquid ejection unit, wherein
the liquid supply unit includes
a supply flow path through which liquid flows toward the liquid ejection unit and
the pressure changing unit according to claim 1,
at least either the liquid supply unit or the liquid ejection unit includes an accommodation section configured to accommodate liquid,
the accommodation section includes a membrane member configured to divide the inside of the accommodation section into an air chamber and a liquid chamber,
the plurality of connect destinations includes the accommodation section, and
the pressure changing unit is configured to change pressure in the air chamber.

8. The liquid ejection device according to claim 7, wherein
the accommodation section is one of a plurality of accommodation sections,
each of the plurality of accommodation sections includes an air chamber,
each of the plurality of accommodation sections is provided in the liquid supply unit or in the liquid ejection unit,
the plurality of connect destinations includes the plurality of accommodation sections, and
the pressure changing unit selectively changes the pressure of the plurality of air chambers.

9. The liquid ejection device according to claim 7, further comprising:
a frame configured to support the pressure changing unit and
a fixing member configured to fix the pressure changing unit to the frame, wherein
the fixing member is configured to be attached to and detached from the pressure changing unit and the frame from above.

10. The liquid ejection device according to claim 9, wherein
the liquid supply unit includes an air flow path connected to the accommodation section and the pump,
the liquid ejection unit includes
an ejection section configured to eject liquid,
a movable body that has mounted thereon the ejection section and that is movable in a scanning direction, and
a flow section mounted on the movable body and connected to the supply flow path and the ejection section,
the flow section includes the accommodation section,
the supply flow path includes a first flexible member that deforms in accordance with movement of the liquid ejection unit in the scanning direction,
the air flow path includes a second flexible member that deforms in accordance with movement of the liquid ejection unit in the scanning direction, and
an upstream end of the first flexible member and an upstream end of the second flexible member are positioned on one side with respect to a center of a movement region of the liquid ejection unit.

11. The liquid ejection device according to claim 10, further comprising:
a bundling member that bundles the first flexible member and the second flexible member, wherein
the bundling member includes a holding section configured to hold the first flexible member and a support section configured to support the second flexible member and
the support section includes a pulley configured to contact the second flexible member.
